(19) United States
(12) Patent Application Publication
(10) Pub. No.: US 2024/0118673 A1
(43) Pub. Date: Apr. 11, 2024

(54) SENSOR AND METHOD FOR INDUSTRIAL MACHINERY MONITORING BASED ON SENSOR DATA PROCESSING BY A MACHINE LEARNING ALGORITHM

(71) Applicant: SORALINK SOLUTIONS, ST-BRUNO-DE-MONTARVILLE (CA)

(72) Inventors: Hsin-Yun YAO, ST-BRUNO-DE-MONTARVILLE (CA); Jean-Samuel CHENARD, ST-BRUNO-DE-MONTARVILLE (CA)

(73) Assignee: SORALINK SOLUTIONS, ST-BRUNO-DE-MONTARVILLE (CA)

(21) Appl. No.: 18/463,351

(22) Filed: Sep. 8, 2023

Related U.S. Application Data
(60) Provisional application No. 63/378,709, filed on Oct. 7, 2022.
(60) Provisional application No. 63/483,785, filed on Feb. 8, 2023.
(60) Provisional application No. 63/579,141, filed on Aug. 28, 2023.

(51) Int. Cl. G05B 19/4065

(52) U.S. Cl. CPC G05B 19/4065; G05B 2219/34477

(57) ABSTRACT

Sensor and method for performing industrial machinery monitoring based on sensor data processing by a machine learning algorithm. The sensor stores a predictive model of the machine learning algorithm and receives measurements generated by at least one sensing component of the sensor. For example, the measurements comprise one or more of the following: a temperature of an industrial machine, a measurement of a vibration of the industrial machine, and a sound intensity of the industrial machine. The sensor executes the machine learning algorithm, which uses the predictive model for inferring output(s) based on inputs. The output(s) comprise at least one predicted operating condition of the industrial machine (e.g. a predicted failure). The inputs comprise at least some of the measurements. The machine learning algorithm may implement a neural network. The predictive model may be updated based on feedback generated by the sensor or received from another device.

### TECHNICAL FIELD

The present disclosure relates to the field of predictive maintenance of industrial machinery. More specifically, the present disclosure relates to a sensor and method for industrial machinery monitoring based on sensor data processing by a machine learning algorithm.

### BACKGROUND

In an industrial machinery environment, a failure affecting an industrial machine generally has a critically negative impact on the operations of the industrial machinery environment. For example, a production chain needs to be stopped until the industrial machine affected by the failure can be repaired. The repair may imply long and complex operations for replacing one or more component of the industrial machine damaged by the failure.

Predictive maintenance processes are generally in place to avoid an unexpected failure affecting an industrial machine. Such processes include for example machine inspection at regular intervals, and scheduled replacement of components of the industrial machine (e.g. to avoid critical wear of a given component, potentially leading to an irremediable damage of the component).

However, based on particular operating conditions of an industrial machine, an unexpected failure may still occur (e.g. between two planned machine inspections or before a planned replacement of components of the industrial machine). Predictive maintenance generally refers to a solution consisting in providing early detection of signs of failures of a variety of industrial machines, allowing a maintenance team to react and plan the necessary interventions on the industrial machine before a failure effectively affects the industrial machine.

Therefore, there is a need for a new sensor and method for industrial machinery monitoring based on sensor data processing by a machine learning algorithm.

### SUMMARY

According to a first aspect, the present disclosure relates to a sensor adapted to perform industrial machinery monitoring based on sensor data processing by a machine learning algorithm. The sensor comprises at least one communication interface and memory storing a predictive model of the machine learning algorithm. The sensor also comprises at least one sensing component adapted to generate measurements. The measurements comprise at least one of the following: a temperature related to an industrial machine, a measurement representative of a vibration related to the industrial machine, and a sound intensity related to the industrial machine. The sensor further comprises a processing unit comprising one or more processor. The processing unit is configured to receive the measurements. The processing unit is configured to execute the machine learning algorithm. The machine learning algorithm uses the predictive model for inferring one or more output based on inputs. The one or more output comprises at least one predicted operating condition of the industrial machine. The inputs comprise at least some of the measurements.

According to a second aspect, the present disclosure relates to a method for performing industrial machinery monitoring based on sensor data processing by a machine learning algorithm. The method comprises storing in a memory of a sensor a predictive model of the machine learning algorithm. The method comprises receiving, by a processing unit of the sensor, measurements generated by at least one sensing component of the sensor. The measurements comprise at least one of the following: a temperature related to an industrial machine, a measurement representative of a vibration related to the industrial machine, and a sound intensity related to the industrial machine. The method comprises executing, by the processing unit of the sensor, the machine learning algorithm. The machine learning algorithm uses the predictive model for inferring one or more output based on inputs. The one or more output comprises at least one predicted operating condition of the industrial machine. The inputs comprise at least some of the measurements.

According to a third aspect, the present disclosure relates to a non-transitory computer-readable medium comprising instructions executable by a processing unit of a sensor. The execution of the instructions by the processing unit of the sensor provides for performing industrial machinery monitoring based on sensor data processing by a machine learning algorithm, by implementing the aforementioned method.

In a particular aspect, the at least one predicted operating condition of the industrial machine comprises at least one of the following: a general failure prediction of the industrial machine and a failure prediction of a component of the industrial machine.

In another particular aspect, the at least one predicted operating condition of the industrial machine comprises at least one of the following: a prediction of a failure of the industrial machine, a prediction of an occurrence of an event related to the industrial machine, a prediction of a production load of the industrial machine, a prediction of a quality of a product produced by the industrial machine, a prediction of a restart cycle pattern of a component of the industrial machine, a prediction of a mechanical load of a component of the industrial machine, and a prediction of a condition for activating an auxiliary sensor in charge of monitoring the industrial machine.

In still another particular aspect, the machine learning algorithm implements a neural network, the predictive model comprising weights of the neural network.

In yet another particular aspect, the inputs of the machine learning algorithm further comprise at least one of the following: an identification of a type of machinery to which the industrial machine belongs and an identification of a type of measurement point of the sensor.

In another particular aspect, the sensor further receives additional data from another device, the additional data being used as inputs of the machine learning algorithm. In a particular embodiment, the other device is another sensor adapted to generate measurements related to the industrial machine. The additional data used as inputs of the machine learning algorithm comprise at least one of the following measurements: a temperature related to the industrial machine generated by the other sensor, a measurement representative of a vibration related to the industrial machine generated by the other sensor, and a sound intensity related to the industrial machine generated by the other sensor.

In still another particular aspect, the one or more output comprises one of the following: a Boolean representative of the predicted operating condition or a probability representative of the predicted operating condition.

In yet another particular aspect, the sensor further transmits to a remote monitoring device information based on the at least one predicted operating condition generated by the machine learning algorithm.

In another particular aspect, the sensor further transmits to a remote training server executing a machine learning training algorithm training data based on at least some of the measurements. The sensor receives from the remote training server the predictive model or an update of the predictive model.

In still another particular aspect, the sensor further updates the predictive model based on a feedback, the feedback being received from another device or the feedback being generated by the sensor based on measurements performed by the sensor or measurements received from another sensor.

### BRIEF DESCRIPTION OF THE DRAWINGS

Embodiments of the disclosure will be described by way of example only with reference to the accompanying drawings, in which:

FIGS. 1, 2, 3 and 4 represent an industrial environment providing industrial machinery monitoring based on sensor data processing by a neural network implemented by a monitoring device in communication with a sensor generating the sensor data;

FIGS. 5 and 6 represent the industrial environment of FIGS. 1-4 with the neural network being implemented by the sensor;

FIG. 7 represents a neural network inference engine executed by the monitoring device of FIGS. 1-4 or the sensor of FIGS. 5-6;

FIG. 8 represents a neural network implemented by the neural network inference engine of FIG. 7;

FIG. 9 represents a method implemented by the sensor of FIGS. 5-6 for performing industrial machinery monitoring based on sensor data processing by a neural network;

FIG. 10 represents a method implemented by the monitoring device of FIG. 3 for performing industrial machinery monitoring based on sensor data processing by a neural network;

FIGS. 11A and 11B illustrate a feedback generated by the monitoring device, being used as input of a machine learning algorithm implemented by the sensor in the industrial environment of FIGS. 1-10;

FIGS. 12A and 12B illustrate a feedback generated by the monitoring device, being used for improving the predictive model of a machine learning algorithm implemented by the sensor in the industrial environment of FIGS. 1-10; and

FIG. 12C illustrates a feedback generated by another source than the monitoring device, being used for improving the predictive model of a machine learning algorithm implemented by the sensor in the industrial environment of FIGS. 1-10

### DETAILED DESCRIPTION

The foregoing and other features will become more apparent upon reading of the following non-restrictive description of illustrative embodiments thereof, given by way of example only with reference to the accompanying drawings.

Various aspects of the present disclosure generally address one or more of the problems related to industrial machinery monitoring. Sensors are deployed to perform measurements related to various industrial machines. Machine learning models are trained to use the collected measurements to predict failures which may affect the industrial machines. The disclosure focuses on the usage of neural networks. However, the teachings of the present disclosure can easily be adapted by a person skilled in the art to any other type of machine learning technique. The present disclosure describes two use cases: the neural network performing the predictions is located on a remote monitoring device and the neural network performing the predictions is located on the sensor.

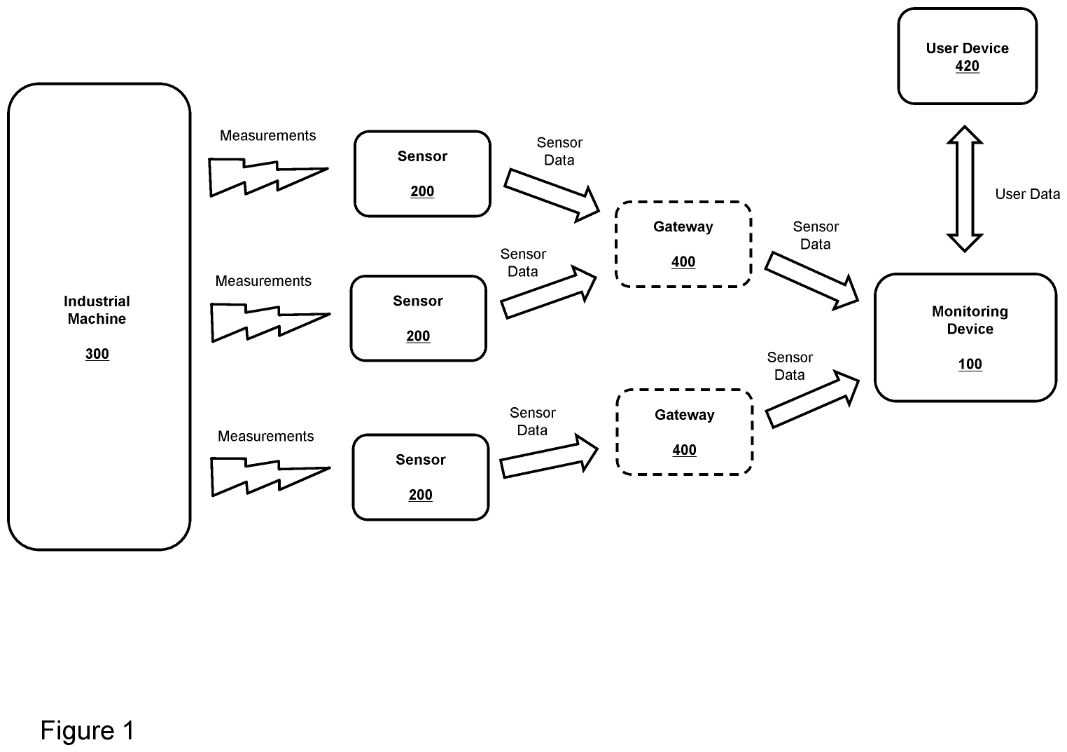

Reference is now made concurrently to FIGS. 1, 2, 3 and 4, which represent an exemplary industrial machinery environment, where industrial machine(s) are deployed. A single industrial machine 300 under the supervision of sensors 200 is represented in the Figures. Each sensor 200 collects measurements related to the industrial machine 300 and generates sensor data based on the measurements, the sensor data being transmitted to a monitoring device 100 for further processing. Optionally, gateways 400 are deployed between the sensors 200 and the monitoring device 100. Each gateway 400 receives the sensor data generated by one or more sensor 200 and forwards these sensor data to the monitoring device 100.

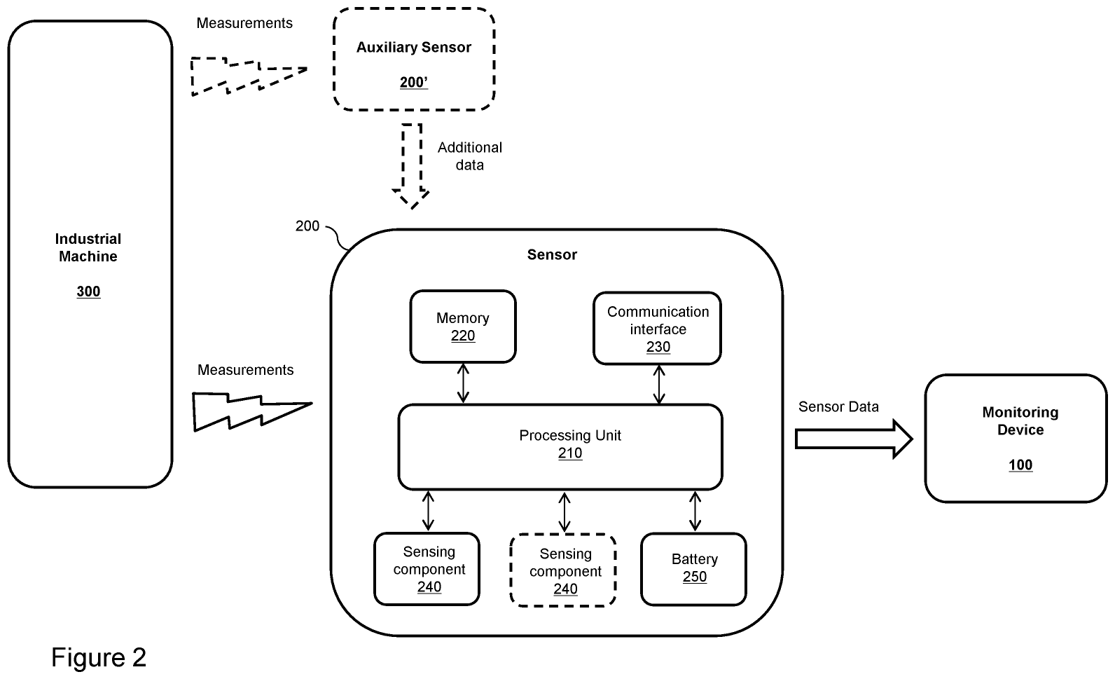

Referring more specifically to FIGS. 1 and 2, the industrial machine 300 may consist of any type of machine used in an industrial context. An example is an industrial machine integrated to a line of production of a product (e.g. automobiles), such as an industrial robot (e.g. a painting robot). The sensor 200 is used for monitoring a machinery feature of the industrial machine 300. The machinery feature is a component of the industrial machine 300, or a sub-component of a component of the industrial machine 300.

Examples of machinery features comprise a motor, a piston head of a compressor, a bearing of a scroll compressor, etc. In many installations, the machinery feature is located on a motor driving a subsystem like a gearbox or a belt pulley. Another example of machinery feature comprises an inlet or an outlet of a thermal compression system.

A classification can be used for improving the monitoring and fault detection process of the industrial machine 300 (generally referred to as classification data augmentation in a machine learning process). The classification comprises an identification of a (generic) type of machinery to which the industrial machine 300 belongs. Each sensor 200 affixed to the industrial machine 300 defines a measurement point. The measurement point identifies a location of the sensor 200 with respect to the industrial machine 300. The classification also comprises an identification of the measurement point among (generic) types of measurement points. Examples of (generic) types of measurement points comprise an inlet, an outlet, a gearbox, an enclosure, etc.

The identification of the type of machinery to which the industrial machine 300 belongs is generally performed at sensor installation. For example, a mobile application using a smartphone camera uses the assistance of cloud recognition image analysis algorithms performing image to context extraction (based on machine learning). Alternatively, the identification of the type of machinery is performed manually by a human being. The deployment of the sensors 200 on the industrial machine 300 can be managed via an installation software, executed for example by a smartphone or a tablet. In this case, the task of performing the identification of the type of machinery to which the industrial machine 300 belongs is integrated to and managed by the installation software.

The identification of the measurement point is also generally performed at sensor installation, and can also be integrated to and managed by the installation software. The measurement point is generally associated with a permanent dedicated zone on the corresponding industrial machine 300. The location of the measurement point is digitally identified. Optionally, the location of the measurement point is also printed on a label affixed on the industrial machine 300 to mark the emplacement of the measurement point.

Referring more specifically to FIG. 2, the sensor 200 comprises a processing unit 210, memory 220, a communication interface 230, and one or more sensing component 240, a battery 250. The sensor 200 may comprise additional components not represented in FIG. 2 for simplification purposes (e.g. an additional communication interface, a user interface, a display, etc.). The optional gateways 400 are not represented in FIG. 2 for simplification purposes.

The processing unit 210 comprises one or more processor (not represented in FIG. 2) capable of executing instructions of a computer program. Each processor may further comprise one or several cores. Alternatively or complementarily, the processing unit 210 comprises one or more FPGA, one or more ASIC, etc.

The memory 220 stores instructions of computer program(s) executed by the processing unit 210, data generated by the execution of the computer program(s), measurements generated by the sensing component(s) 240, data received via the communication interface 230, etc. Only a single memory 120 is represented in FIG. 2, but the monitoring device 100 may comprise several types of memories, including volatile memory (such as a volatile Random Access Memory (RAM), etc.) and non-volatile memory (such as a hard drive, solid-state drive (SSD), electrically-erasable programmable read-only memory (EEPROM), flash, etc.).

The processing unit 210 and memory 220 have been represented as independent electronic components in FIG. 2. Alternatively, the processing unit 210 and memory 220 are integrated into a single electronic component, such as a microcontroller.

The communication interface 230 allows the sensor 200 to exchange data with other devices (e.g. the monitoring device 100 directly or through a gateway 400, etc.) over one or more communication network (not represented in FIG. 2 for simplification purposes). The term communication interface 230 shall be interpreted broadly, as supporting a single communication standard/technology, or a plurality of communication standards/technologies. Examples of communication interfaces 230 include a wireless (e.g. Wi-Fi, Bluetooth®, Bluetooth Low Energy (BLE), cellular, wireless mesh, Bluetooth® coded physical layer, long range (LoRa) physical layer, other proprietary communication protocols, etc.) communication module, a wired (e.g. Ethernet) communication module, a combination of wireless and wired communication modules, etc. The communication interface 230 usually comprises a combination of hardware and software executed by the hardware, for implementing the communication functionalities of the communication interface 230.

The present disclosure is specifically directed to wireless sensors 200, capable of transmitting the sensor data via a wireless communication interface. However, a person skilled in the art would readily understand that the teachings of the present disclosure can be adapted to a sensor 200 using a wired communication interface for transmitting the sensor data.

The sensing component 240 is adapted to perform measurements representative of the operating conditions of the industrial machine 300. The sensor 200 comprises one or more sensing component 240, each sensing component 240 being adapted to perform one or more type of measurement.

Examples of sensing components 240 integrated to the sensor 200 comprise a temperature measurement component (preferably providing a good precision and accuracy, e.g. with a resolution of 0.1 degrees Celsius or higher), a 3-axis accelerometer, a low power microphone, etc. In an exemplary embodiment, the low power microphone has a low power mode able to perform automatic wake-up of the microphone when a sound pressure level goes beyond a pre-defined threshold, or when a potential anomaly is detected.

Optionally, the sensor 200 is capable of receiving additional data related to the industrial machine 300 from another device, for example from another sensor 200′ (referred to as an auxiliary sensor) as illustrated in FIG. 2. The sensor 200′ has characteristics similar to the sensor 200 and the additional data transmitted by the sensor 200′ to the sensor 200 comprise at least some of the measurements (related to the industrial machine 300) generated by the sensor 200′. The measurements generated by the sensor 200′ may be pre-processed, before transmission to the sensor 200. More than one additional device may be transmitting additional data to the sensor 200. Furthermore, the additional device is not limited to a sensor, but encompasses any type of computing device capable of collecting and transmitting information related to the operating conditions of the industrial machine 300.

The additional data are processed by the processing unit 210 of the sensor 200 along with the measurements generated by the sensing component(s) 240 of the sensor 200. For example, the processing comprises transmitting the measurements generated by the sensing component(s) of the sensor 200 and the additional data to the monitoring device 110 in the form of the sensor data represented in FIG. 2. In another example, the processing comprises locally analyzing the measurements generated by the sensing component(s) of the sensor 200 and the additional data (e.g. by means of a neural network, as will be described later).

One example of auxiliary sensor 200′ is an optical, magnetic or quadrature counter capable of counting production output units produced by the industrial machine 300 (bottles, logs, packages, etc.). The counter allows a correlation between machinery vibration measured by the sensor 200 and production output units measured by the counter. Alternatively, the counter is capable of counting production output units produced by another industrial machine different from the industrial machine 300. For example, the industrial machine 300 and the other industrial machine (not represented in FIG. 2) belong to the same production chain.

In another example, the auxiliary sensor 200′ has one or more sensing component comprising at least one of the following: a temperature measurement component, a 3-axis accelerometer, and a low power microphone. The auxiliary sensor 200′ and the sensor 200 perform the same type of measurements, but at different locations (at some distance from one another) on the industrial machine 300. In the case of vibrations measured by a 3-axis accelerometer, the use of the two complementary sensors provides vibration phase (delay) information. In the case of sound intensity measured by a low power microphone, the use of the two complementary sensors provides sound intensity comparison. In the case of temperature measured by temperature measurement component, the use of the two complementary sensors provides temperature gradient information. Furthermore, the evolution over time of the vibration phase, sound intensity comparison and temperature gradient can be tracked.

The additional data measured by the auxiliary sensor 200′ at an auxiliary measurement point can be structured to be sampled very accurately along with the main measurement performed by the main sensor 200 at the main measurement point, allowing the location of a defect on the industrial machine 300 to be pinpointed more accurately than from a single measurement point.

The additional data transmitted by the auxiliary sensor 200′ are received via the main communication interface 230 of the sensor 200. Alternatively, a dedicated communication interface (not represented in FIG. 2) is used for receiving the additional data. The dedicated communication interface may be of the wired or wireless type.

Indirect use of an auxiliary sensor 200′ can be easily derived from attachment of the auxiliary sensor 200′ to an interface port of the main sensor 200, as it can also interface digitally to a 4-20 mA current loop sensor or digital sensors commonly used in industrial systems like One-Wire, Serial Peripheral Interface (SPI), Inter-Integrated Circuit (I2C), Universal Asynchronous Receiver/Transmitter (UART), Controller Area Network (CAN) bus, etc. The interface port on the main sensor 200 uses digital identification of the connected auxiliary sensor 200′ and considers it as a source of additional data for the measurement point of the main sensor 200.

In still another example, the auxiliary sensor 200′ is an air, water or oil pressure sensor, allowing the vibration of a pump measured by the main sensor 200 to be correlated with its immediate demand measured by the auxiliary sensor 200′.

In yet another example, the auxiliary sensor 200′ is an air particles concentration or a carbon dioxide (CO2) level sensor.

In another example, the auxiliary sensor 200′ is a hall sensor that measures the current demand on an electric motor; and correlates it with the corresponding vibration, temperature or sound pattern collected by the main sensor 200.

In still another example, the auxiliary sensor 200′ is a thermocouple measuring hot or cold gases or coolant circulating in refrigeration control systems.

The sensor 200 comprises an enclosure and the sensing component 240 is designed such that a point in a bottom of the enclosure makes a direct contact with the sensing component 240 while the enclosure also makes a direct contact on a top surface of the industrial machine 300. A channel built into the enclosure directs the vibration energy towards the sensing component 240 in the approximate location where an accelerometer of the sensing component 240 is located. In another implementation, the channel conducting the mechanical vibration is made of metal or of a stiff plastic material like ABS or polycarbonate.

In one embodiment, the vibration conducting channel is assisted with a magnetic force coming from the integration of strong magnets (neodymium or similar rare earth) that continually exert a pulling force towards the industrial machine 300 being monitored. Alternatively, the magnetic force is channeled through a metal rod. In an exemplary configuration, the metal rod terminates in a hemispherical point protruding slightly from below a bottom mounting surface of the sensor 200. In another exemplary configuration, the metal rod terminates inside the enclosure of the sensor 200, but in close proximity to a surface of the industrial machine 300 being monitored. In still another exemplary configuration, a tip of the metal rod contains a small adjustment screw that allows the extension of the vibration sensing tip to be controlled, allowing more or less pressure on the surface of the industrial machine 300 being monitored.

Magnets generating the magnetic force can be integrated into a plastic box in areas specifically designed to match corresponding magnets in a cradle (described later in the description). The magnets pull the sensor 200 towards the industrial machine 300.

In a typical installation, the sensor 200 also integrates dual-sided compliant adhesive to its bottom surface. The dual-sided adhesive is comprised of a high surface energy adhesive that initially makes contact with the industrial machine 300. The constant magnetic pulling force exerted by the aforementioned integrated magnets (in the enclosure) constantly apply pressure to the sensor 200 in order to maintain a strong coupling with the industrial machine 300.

The vibration conduction channel generally terminates in a hemispherical point, but can also be shaped to be conical (or shaped to be of any other convenient shape). The shape of the conducting channel helps capture the vibration energy and slightly displaces or compresses any layers of industrial paint between a metal portion of the industrial machine 300 and the conduction channel.

The bottom of the enclosure can be made of polymer or plastics, but a zone of the bottom enclosure is maintained as a plastic conduit carrying the vibrations to the accelerometer (or any other type of acceleration sensing mechanism).

The vibration conduction channel can also contribute to the creation of a thermal bridge that carries a temperature from the external measurement point into the sensor 200, in very close proximity to a temperature sensing component 240 of the sensor 200. In an exemplary configuration, a dedicated cradle permanently attached to the industrial machine 300 is used for this purpose. The dedicated cradle is identified as a measurement point.

The identification of the measurement point is usually accompanied by a corresponding quick-response (QR) code label, but similar means of electronic identification can also be used (e.g. a barcode).

In one embodiment, the cradle comprises a miniature near-field communication (NFC) tag that can be read by a reader inside the sensor 200. The antenna coil portion of the NFC tag is positioned inside the cradle and aligned with the miniature reader antenna located in the sensor 200. Since the cradle is typically mounted on a metallic industrial machine 300, the side most proximate to the metal surface has a layer of high magnetic permeability material which allows the field lines to go under the tag.

In another embodiment, the NFC protocol is emulated by the sensor 200 using an on-board tag emulator, and the interactions between the sensor 200 and the mounting point cradle are performed via a smartphone adapted to read the QR code on the cradle and via an NFC transceiver adapted to push that information to the sensor 200, so as to provision the sensor 200 to be associated with its corresponding measurement point.

The battery 250 is a power source for the various hardware components (e.g. processing unit 210, memory 220, communication interface 230, sensing component 240) of the sensor 200. The battery 250 is a primary or a rechargeable battery. In most configurations, the battery 250 is integrated to the sensor 200, as illustrated in FIG. 2. Alternatively, the battery 250 is in a separate enclosure and is connected to the sensor 200 via a cable. When the battery 250 is integrated to the sensor 200, the battery 250 is generally wired to the sensor 200. Furthermore, the battery 250 is generally mounted on a soft, compliant material (e.g. an open cell foam). This mounting configuration is used to decouple the mass of the battery 250 from at least some of the sensing component(s) 240. For example, in the case of a sensing component 240 comprising an accelerometer, the decoupling is used to protect the battery 250 and associated power wiring from vibrations, but also to allow a mechanically coupled link from the industrial machine 300 to the accelerometer to be as efficient as possible (resulting in an optimized vibration transfer).

Optionally, the sensor 200 is designed to monitor its battery status and adjust its operational parameters based on this information (e.g. adjust the rate at which a sensing component 240 perform measurements and/or transmit corresponding sensor data).

The sensors 200 are designed to be easily installable on a large variety of industrial machines 300. For instance, the design of the sensors 200 is adapted to facilitate a sensor swapping process (sensor technology upgrades, sensor battery recharging, etc.) while maintaining a consistent orientation and position on the industrial machine 300. Furthermore, installation consistency across sensors 200 is maintained, to ensure that collection of sensor data is maintained through the sensor swapping process.

One aspect taken into consideration into the deployment of the presently described industrial machinery monitoring infrastructure, is the sensor replacement process. Each sensor 200 runs on its battery 250, and eventually there is a need to replace either the sensor 200 or the battery 250 of the sensor 200, when the battery 250 gets low. From the perspective of a sensor data analysis performed by the monitoring device 100, it is important that the replacement sensor is placed at the exact same place as the original sensor. Otherwise, the sensor data analysis performed by the monitoring device 100 may need to consider the monitored industrial machine 300 as a completely different machine once the sensor measurement point of the sensor 200 is moved. Thus, a mechanism needs to be implemented, to facilitate the sensor replacement process, while assuring seamless continuity in the sensor data analysis, in particular in the case where machine learning techniques are used for performing the sensor data analysis. One solution to avoid human errors (which may alter the accuracy/validity of the collected sensor data) is to implement a hardware-assisted sensor replacement method, such that a new sensor is identified by hardware and/or software means, rather than by a technician performing the replacement. For example, a software method capable of calibrating the data of the new sensor against the old sensor is used, in order to compensate for the potential differences in the data generated by the old sensor and the new (replacement) sensor, to avoid considering the data generated by the new sensor as an anomaly and triggering false positive alarm(s). Furthermore, the replacement operation needs to be propagated in a timely manner to the monitoring device 100, to ensure the continuity of the sensor data analysis (in particular in the case where machine learning techniques are used, as mentioned previously).

Each sensor 200 is affixed to a corresponding industrial machine 300, to act as a measurement point capable of generating measurements. A given industrial machine 300 may be instrumented with any number (one or several) of sensors 200 respectively providing measurement points. A standard configuration consists in deploying one sensor 200 (providing a corresponding measurement point) at key machinery features of the industrial machine 300, more specifically at an area close to a failure point of the industrial machine 300. Examples of failure points comprise gearboxes (overheating is indicative of a potential failure), ball bearings (overheating and/or anormal vibration is indicative of a potential failure), outlets for coolant (sudden drops of temperature caused by a back flow are indicative of a potential failure), etc.

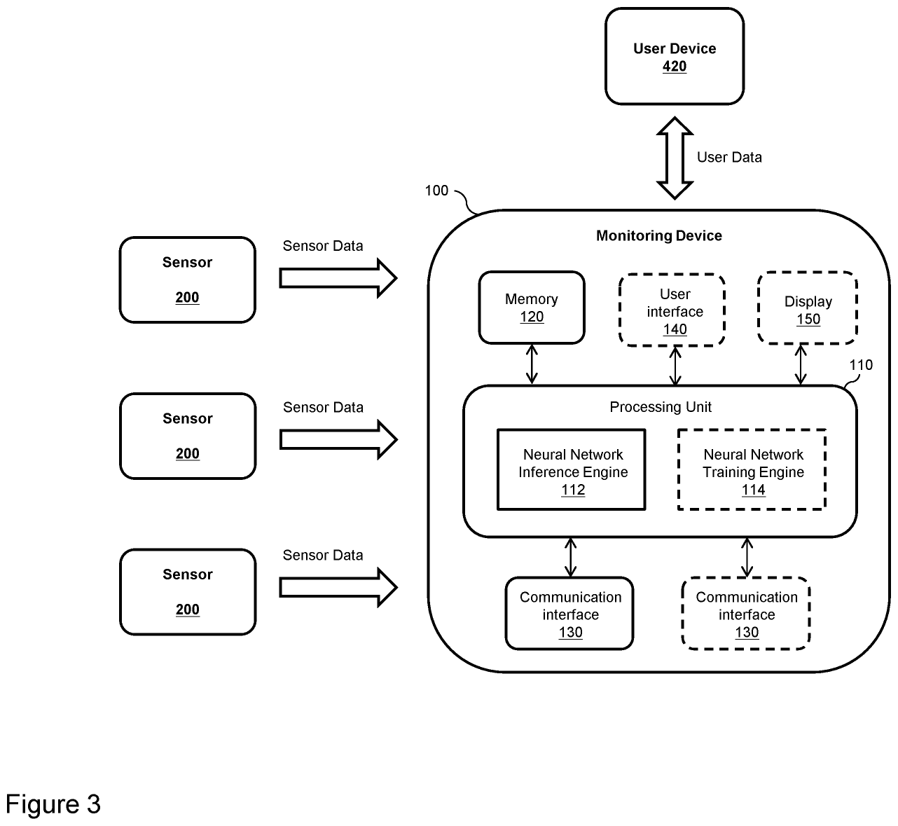

Referring more specifically to FIG. 3, the monitoring device 100 comprises a processing unit 110, memory 120, a communication interface 130, optionally a user interface 140, and optionally a display 150. The monitoring device 100 may comprise additional components not represented in FIG. 3 for simplification purposes (e.g. an additional communication interface 130).

The processing unit 110 comprises one or more processor (not represented in FIG. 3) capable of executing instructions of a computer program. Each processor may further comprise one or several cores.

The memory 120 stores instructions of computer program(s) executed by the processing unit 110, data generated by the execution of the computer program(s), sensor data received from the sensors 200 (directly or through a gateway 400), other data received via the communication interface 130, etc. Only a single memory 120 is represented in FIG. 3, but the monitoring device 100 may comprise several types of memories, including volatile memory (such as a volatile Random Access Memory (RAM), etc.) and non-volatile memory (such as a hard drive, solid-state drive (SSD), electrically-erasable programmable read-only memory (EEPROM), flash, etc.).

Each communication interface 130 allows the monitoring device 100 to exchange data with other devices (e.g. the sensors 200 directly or through a gateway 400, a user device 420, etc.) over one or more communication network (not represented in FIG. 3 for simplification purposes). The term communication interface 130 shall be interpreted broadly, as supporting a single communication standard/technology, or a plurality of communication standards/technologies. Examples of communication interfaces 130 include a wireless (e.g. Wi-Fi, Bluetooth®, Bluetooth Low Energy (BLE), cellular, wireless mesh, etc.) communication module, a wired (e.g. Ethernet) communication module, a combination of wireless and wired communication modules, etc. The communication interface 130 usually comprises a combination of hardware and software executed by the hardware, for implementing the communication functionalities of the communication interface 130. In one exemplary implementation, a first communication interface 130 is dedicated to the reception of the sensor data generated by the sensors 200 (e.g. using a first dedicated Wi-Fi network) and a second communication interface 130 is dedicated to the exchange of data with other devices like the user device 420 (e.g. using a second dedicated Wi-Fi network).

FIG. 3 represents the processing unit 110 executing a neural network inference engine 112 and optionally a neural network training engine 114. During a training phase, the neural network training engine 114 uses the sensor data received from the sensors 200 (along with other data, such as user feedback received from the user device 420 or the user interface 140) to generate one or more predictive model. During an operational phase, the one or more predictive model is used by the neural network inference engine 112 to perform predictions (e.g. prediction of a failure of the industrial machine 300 of FIG. 1) based on the sensor data received from the sensors 200. In a first implementation, the neural network inference engine 112 and the neural network training engine 114 are both executed by the monitoring device 100.

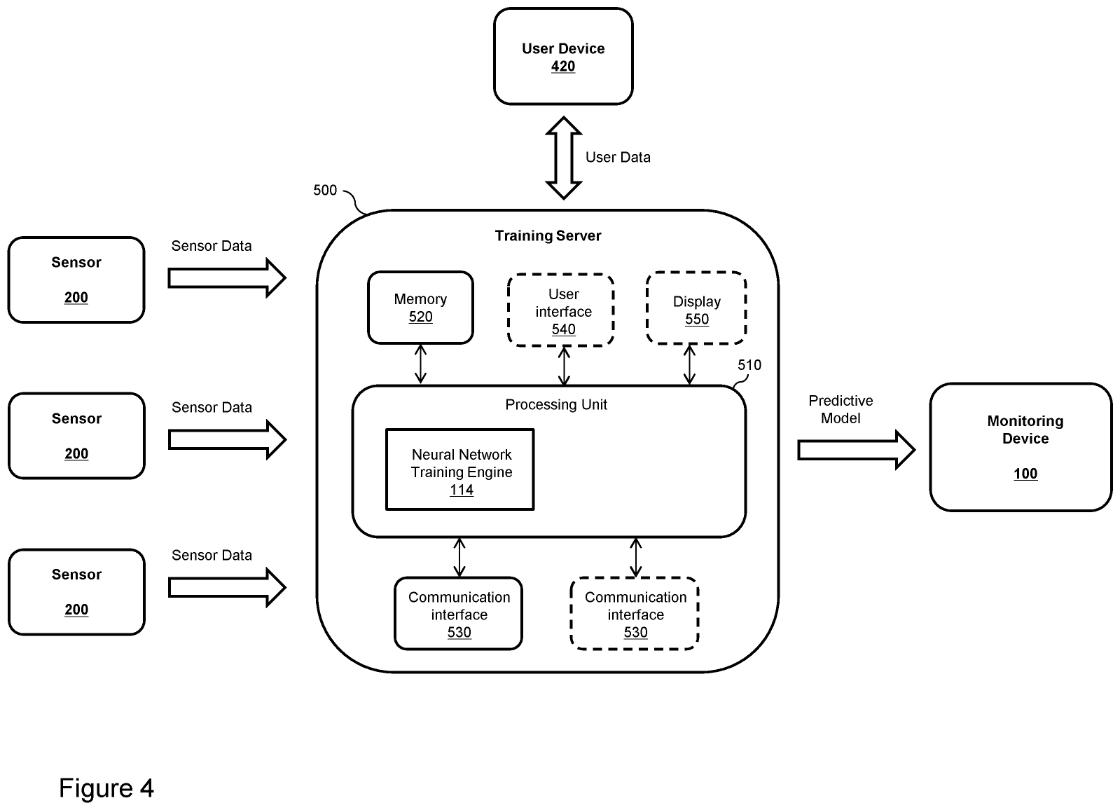

Referring more specifically to FIG. 4, a second implementation is illustrated. The neural network inference engine 112 is executed by the monitoring device 100 and the neural network training engine 114 is executed by a dedicated training server 500. The training server 500 comprises components having characteristics similar to those of the monitoring device 100: a processing unit 510 (executing the neural network training engine 114), memory 520, one or more communication interface 530, optionally a user interface 540, and optionally a display 550. During the training phase, the neural network training engine 114 (executed by the processing unit 510 of the training server 500) uses sensor data received from the sensors 200 (along with other data, such as user feedback received from the user device 420 or the user interface 540) to generate one or more predictive model. Once the training phase is completed, the one or more predictive model generated by the training server 500 is transmitted to the monitoring device 100. The operational phase is similar to the one described in relation to FIG. 3, where the one or more predictive model is used by the neural network inference engine 112 (executed by the processing unit 110 of the monitoring device 100) to perform predictions based on the sensor data received from the sensors 200.

Referring concurrently to FIGS. 3 and 4, at least some of the following functionalities are implemented by the processing unit 110 of the monitoring device 100 and the processing unit 510 of the training server 500: data ingestion, data segregation, anomaly detection, storage, visualization, etc. Each of these functionalities is either integrated to the neural network inference engine 112 and/or the neural network training engine 114, or provided by independent software module(s) in support of the neural network inference engine 112 and/or the neural network training engine 114.

The user feedback received from users (e.g. from machine operators) is used during the training phase to generate the predictive model, and optionally during the operational phase to improve the predictive model through an iterative process.

Referring more specifically to FIG. 1, details of the implementation of the gateway 400 are out of the scope of the present disclosure and not illustrated in the Figures. The gateway 400 generally comprises a processing unit, memory, one or more communication interface, optionally a user interface, optionally a display, etc. One exemplary functionality of the gateway 400 is to provide communication protocol conversion. The sensor data are received by the gateway 400 from the sensor(s) via a first communication protocol (e.g. Bluetooth, BLE, Wi-Fi, LoRa, etc.) and transmitted by the gateway 400 to the monitoring device 100 via a second communication protocol (e.g. Wi-Fi, Ethernet, cellular). The gateway 400 comprises a first communication interface supporting the first communication protocol and a second communication interface supporting the second communication protocol. The gateway 400 uses the processing unit to perform conversion between the first and second communication protocols. One other exemplary functionality of the gateway 400 is to provide data aggregation. Instead of having a plurality of sensors 200 transmitting sensor data to the monitoring device 400, each gateway 400 aggregates the sensor data of a plurality of sensors 200 before transmission to the monitoring device 100. Thus, instead of having the monitoring device 100 interact with a large number of sensors 200, the monitoring device 100 interacts only with a few gateways 400. Furthermore, for each sensor 200, the gateway 400 may collect sensor data over a configurable interval of time, before transmission to the monitoring device 100. For instance, some of the sensors 200 transmit sensor data at a data rate R₁ (e.g. once per minute) and some of the sensors 200 transmit sensor data at a data rate R₂ (e.g. every 5 minutes), while the gateway 400 is configured to transmit aggregated sensor data (from all the sensor 200 under its responsibility) at a lower data rate R₃ (e.g. every 10 minutes). Still another exemplary functionality of the gateway 400 is to implement one or more pre-processing functionality. In this case, instead of simply forwarding the sensor data from the sensors 200 to the monitoring device 100, the sensor data are pre-processed by the gateway 400. For instance, one pre-processing functionality consists in validating the sensor data, to avoid transmitting sensor data which are not valid to the monitoring device 100. The pre-processing functionality may be triggered by the detection of anomalies in the measurements generated by the sensor 200.

### Sensor Implementing a Neural Network

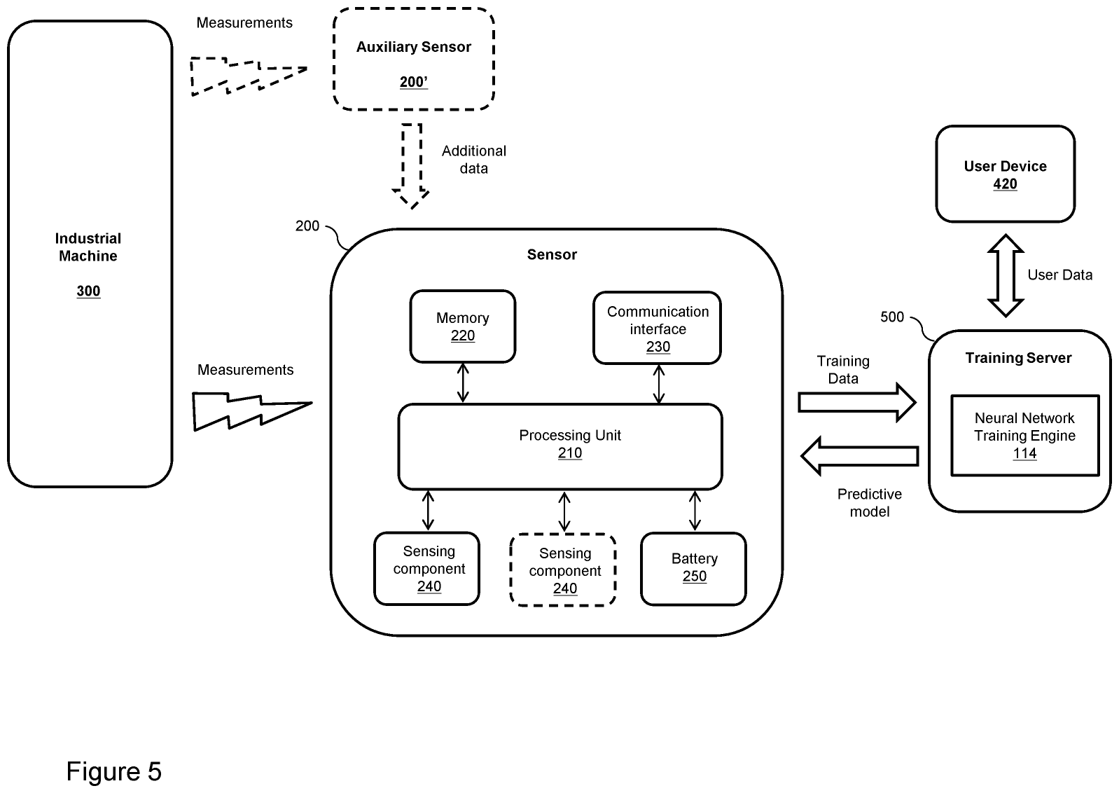

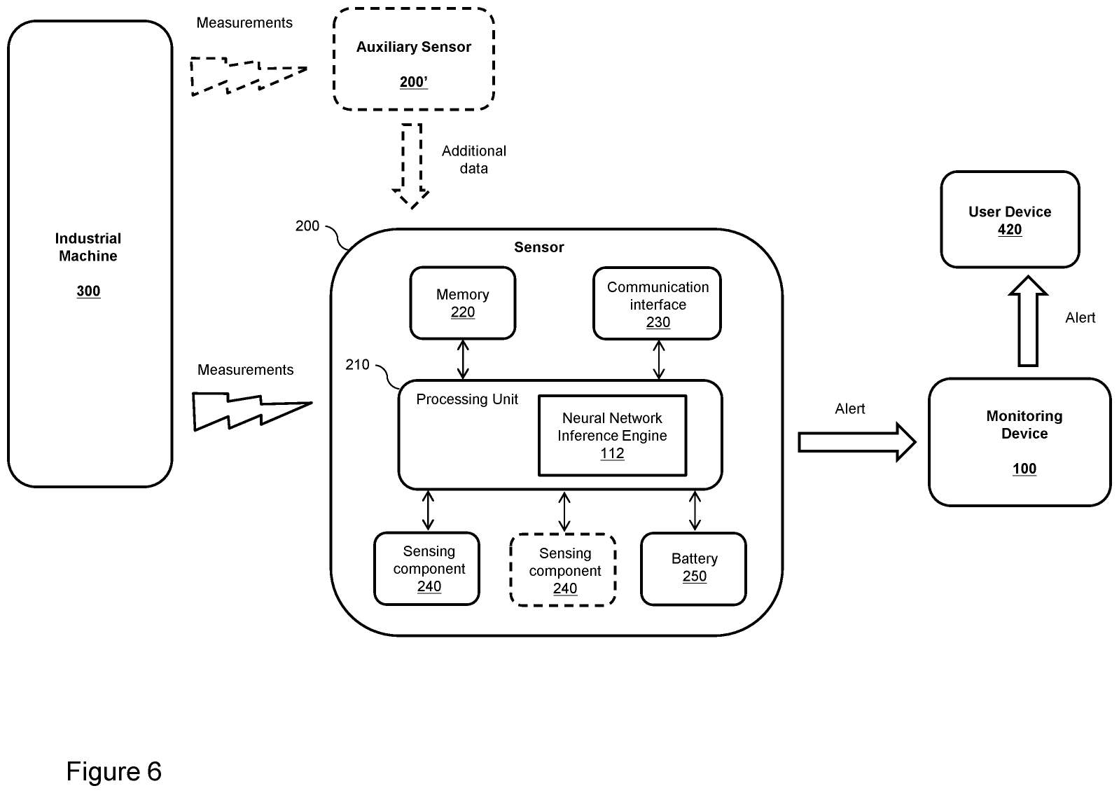

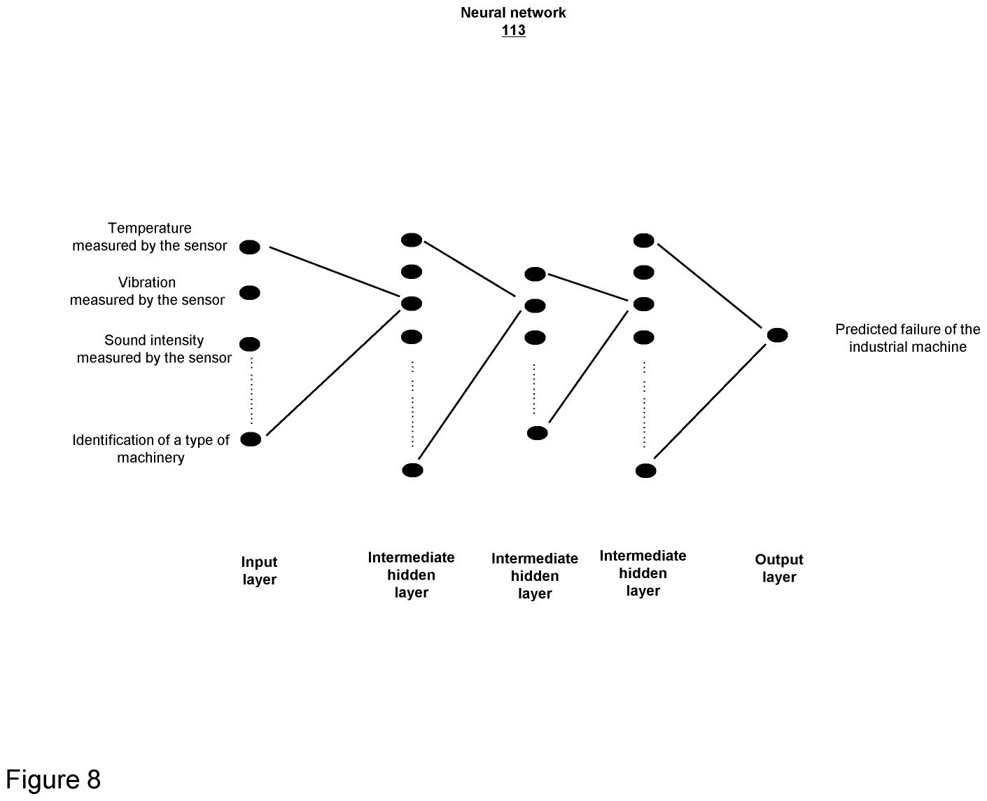

Reference is now made concurrently to FIGS. 5 and 6, which represent another configuration of the industrial machinery monitoring environment, where the sensor 200 implements a neural network. FIG. 5 illustrates the training phase of the neural network. FIG. 6 illustrates the operational phase, where the processing unit 210 of the sensor 200 executes the neural network inference engine 112 (which implements the neural network). The neural network is not represented in FIGS. 5 and 6 for simplification purposes, but an example of neural network is provided in FIG. 8.

Referring more specifically to FIG. 5, the training phase of the neural network is similar to the training phase described previously in relation to FIGS. 3 and 4. The sensor 200 transmits (via the communication interface 230) training data to the training server 500. The components of the of the training server 500 (not represented in FIG. 5 for simplification purposes) are similar to the components of the training server 500 illustrated in FIG. 4. The training server 500 executes the neural network training engine 114 to generate the predictive model of the neural network based on the received training data. Optionally, as mentioned previously in relation to FIG. 4, user feedback (e.g. in the form of user data transmitted by the user device 420) are also used by the neural network training engine 114 for the generation of the predictive model.

When the predictive model is ready, it is transmitted to the sensor 200 by the training server 500. The predictive model is received via the communication interface 230 of the sensor 200 and stored in the memory 220 of the sensor 200, to be used during the operational phase.

As mentioned previously, the training data are based on the measurements generated by the sensing component(s) 240 and optionally on the additional data received from auxiliary sensor(s) 200′.

Although a single sensor 200 is represented in FIG. 5, the training server 500 is capable of generating a plurality of predictive models for a plurality of sensors 200 based on respective training data transmitted by the sensors 200, where the plurality of sensors 200 monitor the same industrial machine 300 or a plurality of industrial machines 300 (not represented in FIG. 5).

Referring more specifically to FIG. 6, the operational phase of the neural network is similar to the operational phase described previously in relation to FIGS. 3 and 4, except that it is performed by the sensor 200.

The processing unit 210 of the sensor 200 executes the neural network inference engine 112, which implements the neural network corresponding to the received predictive model. The neural network uses the predictive model to generate output(s) based on inputs. The inputs are based on the measurements generated by the sensing component(s) 240 and optionally on the additional data received from auxiliary sensor(s) 200′. Details relative to the neural network inference engine 112 and the neural network will be provided later in the description. The output(s) of the neural network are representative of the potential occurrence of a failure of the industrial machine 300. Upon positive detection of the potential occurrence of a failure (the failure is likely to occur in the future), an alert message is transmitted to the monitoring device 100. The alert message identifies the type of failure and the sensor 200 reporting the problem.

Upon reception of the alert message, the monitoring device 100 takes one or more corresponding action. An example of action consists in displaying on the display 150 (represented in FIG. 3) of the monitoring device 100 information related to the potential failure likely to affect the industrial machine 300. Another example of action consists in transmitting to the user device 400 information related to the potential failure likely to affect the industrial machine 300, to be displayed on a display of the user device 420.

Although a single sensor 200 is represented in FIG. 6, the monitoring device 100 is capable of processing alert messages generated by a plurality of sensors 200, where the plurality of sensors 200 monitor the same industrial machine 300 or a plurality of industrial machines 300 (not represented in FIG. 6).

As illustrated in FIG. 3, the functionalities of the training server 500 (in particular the neural network training engine 114) of FIG. 5 may be integrated to the monitoring device 100 of FIG. 6.

The sensor 200 is not limited to the usage of a neural network for locally analyzing the measurements and additional data collected by the sensor 200. Other examples of analysis comprise another type of machine learning technology, frequency domain analysis, spectral analysis, etc. Furthermore, the sensor 200 is not limited to sending alert messages to the monitoring device 100. Other types of information based on the results of the analysis performed by the sensor 200 can be transmitted to the monitoring device 100. Furthermore, during the operational phase, the predictive model and more generally the parameters of the analysis can be updated via commands received from the monitoring device 100.

Furthermore, the output(s) of the neural network are not limited to the prediction of the potential occurrence of a failure of the industrial machine 300. Other types of output(s) of the neural network include the following types of predicted operating conditions of the industrial machine 300: prediction of the occurrence of an event related to the industrial machine 300, prediction of a production load of the industrial machine 300, prediction of a quality of a product produced by the industrial machine 300, prediction of a restart cycle pattern of a component of the industrial machine 300 (e.g. a compressor), prediction of a load and/or usage (e.g. mechanical load) of a component of the industrial machine 300 (e.g. a pump, a motor, a gearbox, etc.), prediction of a condition for activating an auxiliary sensor 200′ in charge of monitoring the industrial machine 300, etc.

With respect to the prediction of the quality of a product produced by the industrial machine 300, an exemplary use case is a machine 300 using one or more liquid ingredients to produce a final product (e.g. bread, chocolate, rubber used for making tires, etc.). The quality of the final product depends on a proper execution of a mixing process, which is itself dependent on the viscosity of the liquid ingredient(s). The mechanical load on a motor and/or gearbox of the machine 300 implementing the mixing process is dependent on the viscosity of the liquid ingredient(s). Thus, by collecting inputs representative of the mechanical load on the motor and/or gearbox of the machine 300 (e.g. sound intensity, vibration, etc.), the neural network is capable of using these inputs to predict the quality of the final product.

With respect to the prediction of a condition for activating an auxiliary sensor 200′, the auxiliary sensor 200′ does not collect data related to the industrial machine 300 all the time. The collection of data is performed only when the industrial machine 300 is operating in particular conditions, in a particular phase of an industrial process, etc. The inputs of the neural network (e.g. sound intensity, vibration, temperature, etc.) are representative of the operating conditions/phase of the industrial process. Thus, the neural network is capable of using these inputs to predict if a condition for activating the auxiliary sensor 200′ is met. For example, activating the auxiliary sensor 200′ comprises sending a command to the auxiliary sensor 200′, to trigger collection of data by the auxiliary sensor 200′ and transmission of the collected data to the sensor 200.

With respect to the prediction of the occurrence of an event related to the machine 300, an exemplary use case is the detection of water hammering occurring in a pipe. Water hammering occurs due to a pressure surge, which is not necessarily representative of potential damage to the machine 300, but which may indicate that the machine 300 is not properly configured and is therefore not operating optimally. The neural network is capable of using its inputs (e.g. sound intensity, vibration, etc.) to predict the occurrence of water hammering. In this case, the predicted occurrence includes a detection that the event has happened or a detection that the event is going to happen.

### Description of the Neural Network

The neural network technology relies on the collection of a large quantity of data during the training phase, which are used for training the neural network. The result of the training phase is the predictive model generated by the neural network. Then, during the operational phase, the neural network uses the predictive model to generate predicted output(s) based on inputs.

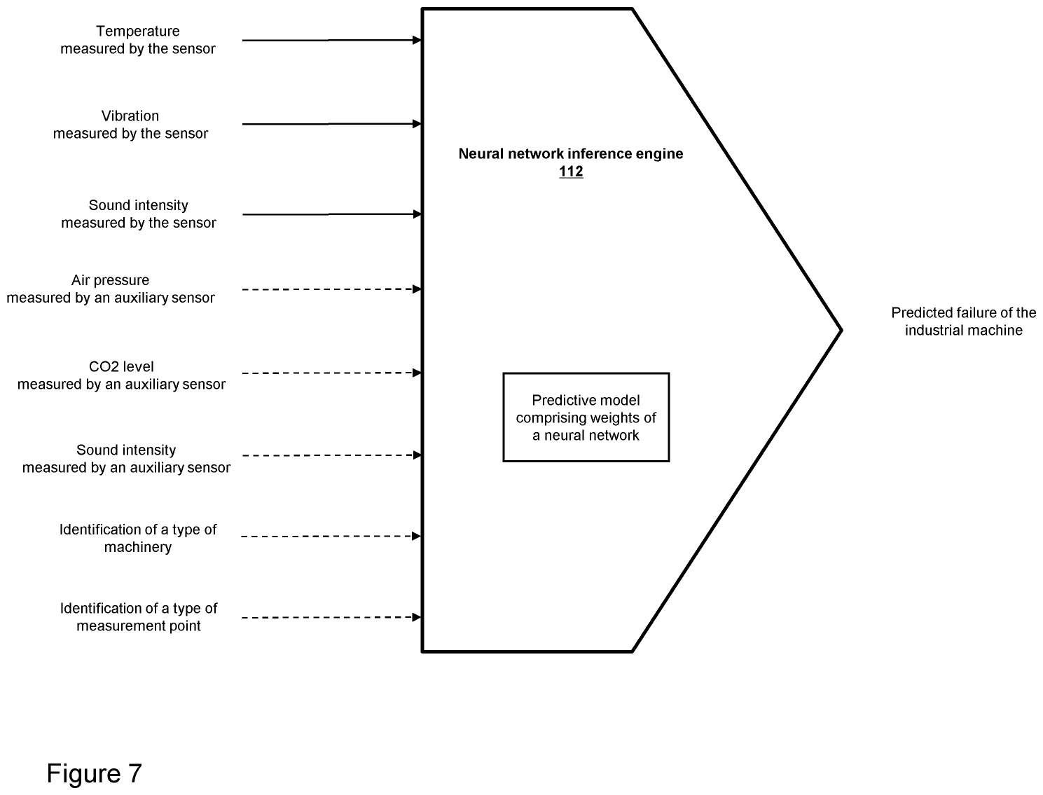

Although the disclosure is generally based on the usage of a neural network, a person skilled in the art would readily understand that other machine learning technologies may be used in place of a neural network (e.g. linear regression, logistic regression, decision tree, support vector machine (SVM) algorithm, K-nearest neighbors algorithm, K-means algorithm, random forest algorithm, etc.). The neural network is used to predict a failure of an industrial machine using inputs generated by sensor(s) through collection of measurements (and optionally additional information) related to the industrial machine. More generally, a machine learning algorithm (corresponding to the neural network inference engine 112 represented in FIG. 7) uses a predictive model adapted to the type of machine learning technology being used, to predict output(s) (e.g. to predict a failure of an industrial machine) based on inputs. As is the case for neural networks, the predictive model used by the machine learning algorithm is generated during a training phase, using a training algorithm (corresponding to the neural network training engine 114 represented in FIG. 5).

Reference is now made concurrently to FIGS. 5, 6, 7 and 8. FIG. 7 is a schematic representation of the neural network inference engine 112 executed by the processing unit 210 of the sensor 200, with its inputs and its output(s). FIG. 8 provides a detailed representation of a neural network 113 implemented by the neural network inference engine 112.

The inputs received by the neural network inference engine 112 comprise at least some of the data collected by the sensor 200. The data comprise the measurements generated by the sensing component(s) 240 of the sensor 200. Optionally, the data also comprise the additional data received from a remote device (e.g. from one or more auxiliary sensor 200′). Optionally, at least some of the measurements and additional data are pre-processed (e.g. filtered, smoothed, averaged, etc.) before being used as inputs of the neural network inference engine 112. All the inputs are related to the industrial machine 300 under supervision of the sensor 200.

Candidate inputs of the neural network inference engine 112 have been described previously. The inputs comprise any combination of the following:
a temperature (or a series of consecutive temperatures) related to the machine 300 and measured by the sensor 200;
a temperature (or a series of consecutive temperatures) related to the machine 300 and measured by the auxiliary sensor 200′;
a temperature gradient (or a series of consecutive temperature gradients) related to the machine 300, based on temperature measurements of the sensor 200 and auxiliary sensor 200′;
a measurement representative of a vibration (or a series of measurements representative of a vibration) related to the machine 300 and measured by the sensor 200 (the term measurement shall be interpreted broadly as comprising one or more value, for example the measurement comprises three components measured by a 3 axis accelerometer);
a measurement representative of a vibration (or a series of measurements representative of a vibration) related to the machine 300 and measured by the auxiliary sensor 200′;
a vibration phase (or a series of vibration phases) related to the machine 300, based on vibration measurements of the sensor 200 and auxiliary sensor 200′;
a sound intensity (or a series of consecutive sound intensities) related to the machine 300 and measured by the sensor 200;
a sound intensity (or a series of consecutive sound intensities) related to the machine 300 and measured by the auxiliary sensor 200′;
a sound intensity comparison metric (or a series of consecutive sound intensity comparison metrics) related to the machine 300, based on sound intensity measurements of the sensor 200 and auxiliary sensor 200′;
an identification of a type of machinery (among a plurality of pre-defined types of machinery) to which the industrial machine 300 belongs;
an identification of a type of measurement point (among a plurality of pre-defined types of measurement points) of the sensor 200;
an identification of a type of measurement point (among a plurality of pre-defined types of measurement points) of the auxiliary sensor 200′;
a number of production output units (or a series of consecutive numbers of production output units) of the industrial machine 300 or another industrial machine (belonging to the same production chain) measured by the auxiliary sensor 200′;
at least one of an air pressure, water pressure, oil pressure, air particles concentration, carbon dioxide (CO2) level, etc. (or at least one of a series of consecutive air pressure, water pressure, oil pressure, air particles concentration, carbon dioxide (CO2) level, etc.) related to the machine 300 and measured by the auxiliary sensor 200′;
a current demand (or a series of consecutive current demands) on an electric motor of the machine 300 measured by the auxiliary sensor 200′;
a temperature of hot or cold gases or coolant (or a series of consecutive temperatures of hot or cold gases or coolant) related to the machine 300 and measured by the auxiliary sensor 200′.

Although reference is made (for simplification and clarity purposes) to a single auxiliary sensor 200′ in the previous list of input parameters of the neural network, a person skilled in the art would readily understand that the source of auxiliary data for the inputs may consist of one or more auxiliary sensor 200′. Furthermore, some of the measurements described as being generated by the auxiliary sensor 200′ may also be generated directly by the main sensor 200.

FIGS. 7 and 8 illustrate an example of inputs received by the neural network inference engine 112, processed by the neural network 113, to generate predicted output(s). In this example, the inputs comprise a temperature measured by the sensor 200, a measurement representative of a vibration measured by the sensor 200 and a sound intensity measured by the sensor 200. Optionally, the inputs further comprise any combinations of one or more of the following parameters: an air pressure measured by the auxiliary sensor 200′, a CO2 level measured by the auxiliary sensor 200′, a sound intensity measured by the auxiliary sensor 200′, an identification of a type of machinery (for the industrial machine 300) and an identification of a type of measurement point (for the industrial machine 300). Furthermore, as mentioned previously, a series of consecutive values of a given parameter may be used as inputs instead of a single value for the given parameter (e.g. for one or more of the temperature, vibration, sound intensity, air pressure and CO2 level measurements). Only some of the inputs represented in FIG. 7 are represented in FIG. 8 for simplification and clarity purposes.

With respect to the output(s) generated by the neural network 113 implemented by the neural network inference engine 112, the one or more output comprises at least one predicted failure of the industrial machine 300. For example, the one or more output comprises a general predicted failure of the industrial machine 300, where the general predicted failure is not related to a specific component of the industrial machine 300. In another example, the one or more output comprises one predicted failure of a component of the industrial machine 300 (e.g. prediction of a gearbox failure, a component unbalance, a bearing failure, a valve failure (e.g. in compressors), an air intake failure (e.g.) in coolant circulation, etc.). In still another example, the one or more output comprises several predicted failures of respective corresponding components of the industrial machine 300.

In one exemplary implementation, the one or more output comprises a Boolean representative of the failure prediction (e.g. true if a future failure is predicted and negative if a future failure is not predicted). In another exemplary implementation, the one or more output comprises a probability of occurrence of the failure (e.g. a percentage of chances that the failure will occur or alternatively a percentage of chances that the failure will not occur). FIGS. 7 and 8 illustrate an example where there is only one output (e.g. a Boolean or a probability) providing a failure prediction.

The prediction/probability of occurrence of the failure can be used to trigger additional analysis. For example, if a failure is predicted, one or more additional software is executed by the sensor 200 to confirm or invalidate the prediction/probability of occurrence of the failure. Alternatively or complementarily, the prediction/probability of occurrence of the failure is transmitted to another device (e.g. the monitoring device 100 of FIG. 6), which executes the one or more additional software to confirm or invalidate the prediction/probability of occurrence of the failure.

The neural network 113 illustrated in FIG. 8 comprises an input layer with a number of neurons adapted for receiving any of the combinations of inputs which have been previously described. For simplification purposes, FIG. 8 only illustrates one neuron of the input layer receiving a temperature measured by the sensor 200, one neuron of the input layer receiving a measurement representative of a vibration measured by the sensor 200, one neuron of the input layer receiving a sound intensity measured by the sensor 200, and one neuron of the input layer receiving an identification of a type of machinery for the industrial machine 300.

The neural network comprises an output layer with one or more neuron. FIG. 8 illustrates an exemplary implementation with a single neuron in the output layer for outputting a failure prediction (e.g. a Boolean or a probability) of the industrial machine 300.

The number of neurons of the input layer, the inputs, the number of neurons of the output layer and the outputs represented in FIG. 8 are for illustration purposes only, and can be adapted to support more or less inputs, other types of inputs, more or less outputs, and other types of outputs.

The neural network 113 comprises three intermediate hidden layers between the input layer and the output layer. All the layers are fully connected. A layer L being fully connected means that each neuron of layer L receives inputs from every neurons of layer L−1, and applies respective weights to the received inputs. By default, the output layer is fully connected to the last hidden layer. The number of intermediate hidden layers is an integer greater or equal than 1 (FIG. 8 represents three intermediate hidden layers for illustration purposes only). The number of neurons in each intermediate hidden layer may vary. During the training phase of the neural network 113, the number of intermediate hidden layers and the number of neurons for each intermediate hidden layer are selected, and may be adapted experimentally. The generation of the outputs based on the inputs using weights allocated to the neurons of the neural network 113 is well known in the art. The architecture of the neural network, where each neuron of a layer (except for the first layer) is connected to all the neurons of the previous layer is also well known in the art.

The neural network 113 may also use convolution layer(s) and optionally pooling layer(s) following the convolution layer(s). The convolution layer(s) and pooling layer(s) are implemented between the input layer and the first intermediate layer. The final outputs generated by the convolution layer(s) and pooling layer(s) are used as inputs of the first intermediate hidden layer. For example, a convolution is applied when temporal series of measurements (e.g. temperature, vibration or sound intensity) are used as inputs of the neural network 113.

As mentioned previously, the one or more output of the neural network 113 is not limited to the prediction of a failure affecting the industrial machine 300, but may also predict any of the previously mentioned operating conditions of the industrial machine 300.

Although the functionalities and operations of the neural network 113 and neural network inference engine 112 have been described when executed by the sensor 200, the aforementioned functionalities and operations are also applicable when executed by the monitoring device 100 (as previously described in relation to FIG. 3). In particular, in the context of an industrial system comprising a plurality of industrial machines 300 (e.g. a coolant circulating system in a food manufacturing plant), a plurality of sensors 200 are deployed to collect and transmit sensor data to the monitoring device 100 (as illustrated in FIG. 3). A neural network is executed by the monitoring device 100, using the sensor data from the multiple sensors 200 to make failure prediction(s) (or other types of predictions) related to the entire system comprising the plurality of industrial machines 300. Alternatively, a main sensor 200 implementing the neural network 113 and a plurality of auxiliary sensors 200′ are used to monitor the entire system comprising the plurality of industrial machines 300.

Following is a description of the training phase, which results in the generation of the predictive model of the neural network 113. During the training phase, the neural network training engine 114 is trained with a plurality of inputs and a corresponding plurality of outputs. The types of inputs and outputs used during the training phase are the same as the types of inputs and outputs used during the operational phase.

The neural network training engine 114 is executed by a processing unit (not represented in FIG. 5 for simplification purposes) of the training server 500. Once the training is completed, the predictive model is transmitted to the sensor 200. The predictive model is received via the communication interface 230 and stored in the memory 220 of the sensor 200. During the operational phase, the predictive model stored in the memory 220 is used by the neural network inference engine 112 executed by the processing unit 210 of the sensor 200.

As is well known in the art of neural networks, during the training phase, the neural network 113 implemented by the neural network training engine 112 adjusts its weights. Furthermore, during the training phase, the number of layers of the neural network 113 and the number of nodes per layer can be adjusted to improve the accuracy of the model. At the end of the training phase, the predictive model generated by the neural network training engine comprises the number of layers, the number of neurons per layer, and the weights.

Various techniques well known in the art of neural networks are used for performing (and improving) the generation of the predictive model, such as supervised and unsupervised learning, forward and backward propagation, usage of bias in addition to the weights (bias and weights are generally collectively referred to as weights in the neural network terminology), reinforcement learning, etc.

From an implementation perspective, the machine learning training is generally performed separately offline, and is not part of the primary data processing pipeline taking place during the operational phase. Several candidate predictive models based on different theoretical principles can be built, trained with the datasets obtained from sensors 200 deployed on real industrial machines 300. Performances of the candidate predictive models are compared, in order to select the best predictive model among the candidate predictive models. Ideally, the same predictive model can be used in reference to different kinds of industrial machines and operational modes of the industrial machines. The aim is to develop a small number of predictive models compatible with a large diversity of industrial machines.

From an implementation perspective, the machine learning models can be supervised or not. In the case where they are supervised, a software pipeline can be used to automate (as much as possible) a labelling of the training data. The labeling can be performed via a software labelling algorithm or via human feedback. In the case of human feedback, software can also be used to provide a user interface to facilitate and automate human feedback. The human feedback can be provided by operators (of the industrial machines) labeling the datasets and/or corresponding alarms. Alternatively, the feedback is provided via an automated alert system that incorporates cloud-enabled features, such as speech synthesis and alarm summary. A similar mechanism similar for providing feedback can be obtained using a chat program. The chat program can be piloted with a chatbot allowing a user to dig deeper in the diagnostic process and obtain sensor data. The chatbot or feedback system correlates the response to the event timing and automatically creates a label for the alarm corresponding to the datasets. This label is then immediately (or in future batch processing) used to adjust the machine learning model through the process of reinforcement learning.

It has been observed experimentally that a large variety of industrial machines are critical and require constant monitoring in various manufacturing environments. In addition, the industrial machines generally operate under different conditions depending on the manufacturer, the production load, seasonal variations, weather conditions, etc. To overcome this challenge, it is needed to regularly communicate with the machine operators, to validate the parameters of the predictive models. However, it has been observed that in most cases, there is a pattern to the industrial machine behavior. Thus, with the generation of datasets with correct labels, eventually the need for operator feedback can be much reduced.

### Method for Performing Industrial Machinery Monitoring Based on Sensor Data Processing by a Neural Network Executed on a Sensor

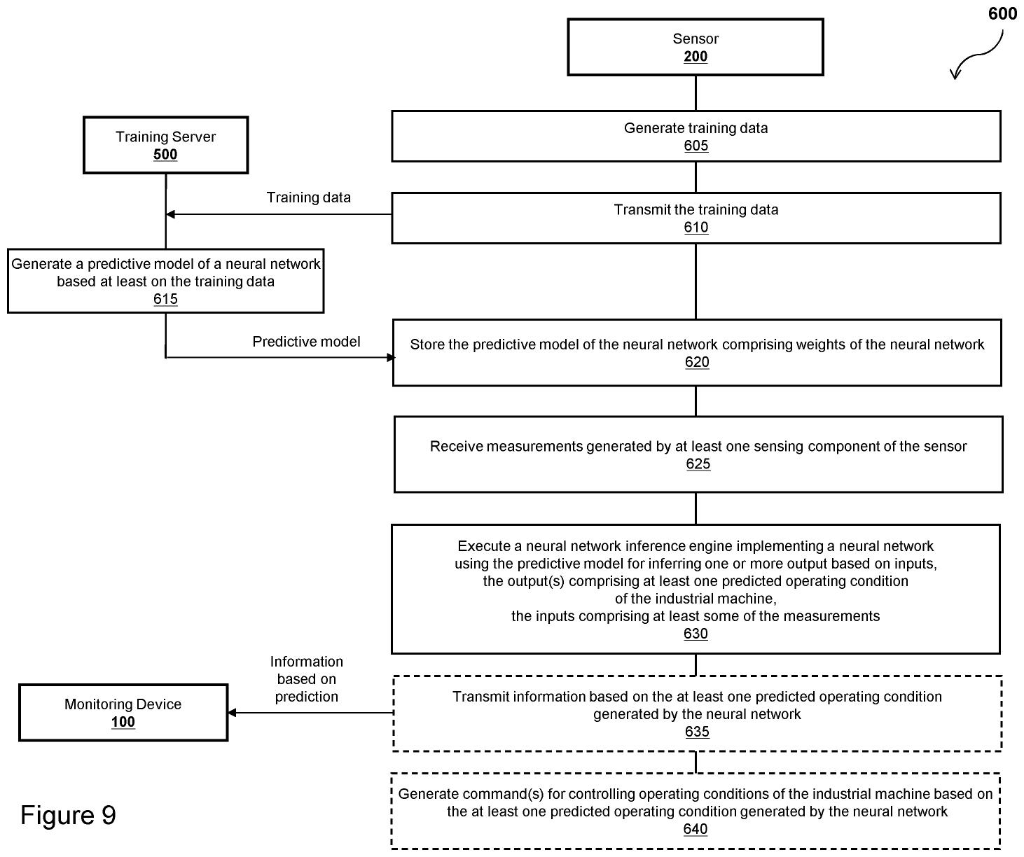

Reference is now made concurrently to FIGS. 5, 6, 7, 8 and 9, where FIG. 9 represents a method 600 for performing industrial machinery monitoring based on sensor data processing by a neural network. At least some of the steps of the method 600 are implemented by the processing unit 210 of the sensor 200.

Furthermore, a dedicated computer program has instructions for implementing at least some of the steps of the method 600. The instructions are comprised in a non-transitory computer-readable medium (e.g. in the memory 220) of the sensor 200. The instructions, when executed by the processing unit 210, provide for performing industrial machinery monitoring based on sensor data processing by a neural network. The instructions are deliverable to the sensor 200 via an electronically-readable media such as a storage media (e.g. any internally or externally attached storage device connected via USB, Firewire, SATA, etc.), or via communication links (e.g. via a communication network through the communication interface 230).

The method 600 comprises the step 605 of generating training data based on at least some of the measurements generated by the sensing component(s) 240 of the sensor 200. Step 605 is executed by the processing unit 210 of the sensor 200.

The method 600 comprises the step 610 of transmitting the training data to the training server 500 via the communication interface 230 of the sensor 200. Step 610 is executed by the processing unit 210 of the sensor 200.

The step of receiving by the training server 500 the training data from the sensor 200 is not represented in FIG. 9 for simplification purposes.

The method 600 comprises the step 615 of generating (by the neural network training engine 114) the predictive model of the neural network 113 based at least one training data. Step 615 is executed by the training server 500.

The step of transmitting by the training server 500 the predictive model to the sensor 200 and the step of receiving by the sensor 200 via the communication interface 230 the predictive model from the training server 500 are not represented in FIG. 9 for simplification purposes.

The method 600 comprises the step 620 of storing the predictive model of the neural network 113 in the memory 220 of the sensor 200. Step 620 is executed by the processing unit 210 of the sensor 200. The predictive model comprises the weights of the neural network 113.

The method 600 comprises the step 625 of receiving measurements generated by the at least one sensing component 240 of the sensor 200. For example, the measurements comprise at least one of the following: a temperature related to the industrial machine 300, a measurement representative of a vibration related to the industrial machine 300, and a sound intensity related to the industrial machine 300. Step 625 is executed by the processing unit 210 of the sensor 200.

The method 600 comprises the step 630 of executing the neural network inference engine 112. The neural network inference engine 112 implements the neural network 113, which uses the predictive model for inferring one or more output based on input. The one or more output comprises at least one predicted operating condition of the industrial machine 300. The inputs comprise at least some of the measurements (received at step 625). Step 630 is executed by the processing unit 210 of the sensor 200.

As mentioned previously, the predicted operating condition(s) inferred by the neural network 113 include without limitations: prediction of a failure of the industrial machine 300, prediction of the occurrence of an event related to the industrial machine 300, prediction of a production load of the industrial machine 300, prediction of a quality of a product produced by the industrial machine 300, prediction of a restart cycle pattern of a component of the industrial machine 300, prediction of a load and/or usage (e.g. mechanical load) of a component of the industrial machine 300, prediction of a condition for activating an auxiliary sensor 200′ in charge of monitoring the industrial machine 300, etc.

Although details related to the implementation of step 630 are provided with respect to predicted operating condition(s) consisting of predicted failure(s) of the industrial machine 300, a person skilled in the art will readily adapt the implementation of step 630 to the aforementioned other types of predicted operating condition(s) generated by the neural network 113. Furthermore, a person skilled in the art will readily adapt the implementation of step 630 to other types of machine learning algorithms (using the same inputs for generating the same outputs as the neural network 113).

In an exemplary implementation mentioned previously, the measurements (received at step 625) used as inputs comprise at least one of the following: the temperature related to the industrial machine 300, the measurement representative of a vibration related to the industrial machine 300, and the sound intensity related to the industrial machine 300. However, any combination of the inputs which have been described previously in relation to FIGS. 7 and 8 are applicable to step 630.

As mentioned previously, a person skilled in the art would readily adapt the method 600 to use other types of machine learning algorithms in place of the neural network 113 disclosed at step 630.

The method 600 comprises the optional step 635 of transmitting to the monitoring device 100 (via the communication interface 230) information based on the at least one predicted operating condition (e.g. predicted failure) generated at step 630 (e.g. an alert indicating that a failure of the industrial machine 300 is likely to occur). Step 635 is executed by the processing unit 210 of the sensor 200. In an exemplary implementation, step 635 is executed only if the failure prediction of the industrial machine 300 is positive (a failure is likely to occur). In this case, the information transmitted to the monitoring device 100 is an alert indicating that the failure is likely to occur.

The details of the processing by the monitoring device 100 of the information (transmitted by the sensor 200) are not represented in FIG. 9 for simplification purposes. Examples of such processing of the information by the monitoring device 100 have been described previously.

Alternatively to or complementarily to step 635, the method 600 comprises the optional step 640 of generating one or more command for controlling operating conditions of the industrial machine 300 based on the at least one predicted operating condition (e.g. predicted failure) generated at step 630. Step 640 is executed by the processing unit 210 of the sensor 200. In an exemplary implementation, step 640 is executed only if the failure prediction of the industrial machine 300 is positive (a failure is likely to occur). Examples of commands comprise turning on or turning off the industrial machine 300, controlling the speed of a motor of the industrial machine 300, opening or closing relays of the industrial machine 300, changing an operating status (e.g. idle, stand by, active, etc.) of the industrial machine 300, etc.

The one or more command is transmitted via the communication interface 230 of the sensor 200 to a control device (not represented in the Figures). The control device is capable of executing the one or more command to control the operating conditions of the industrial machine 300. For example, the control device is integrated to the industrial machine 300. The control device comprises communication capabilities for receiving the one or more command from the sensor 200. The control device comprises processing capabilities for processing the one or more command received from the sensor 200 to generate corresponding actuation control signal(s). The control device comprises actuation capabilities for enforcing the actuation control signal(s).

### Method for Performing Industrial Machinery Monitoring Based on Sensor Data Processing by a Neural Network Executed on a Monitoring Device

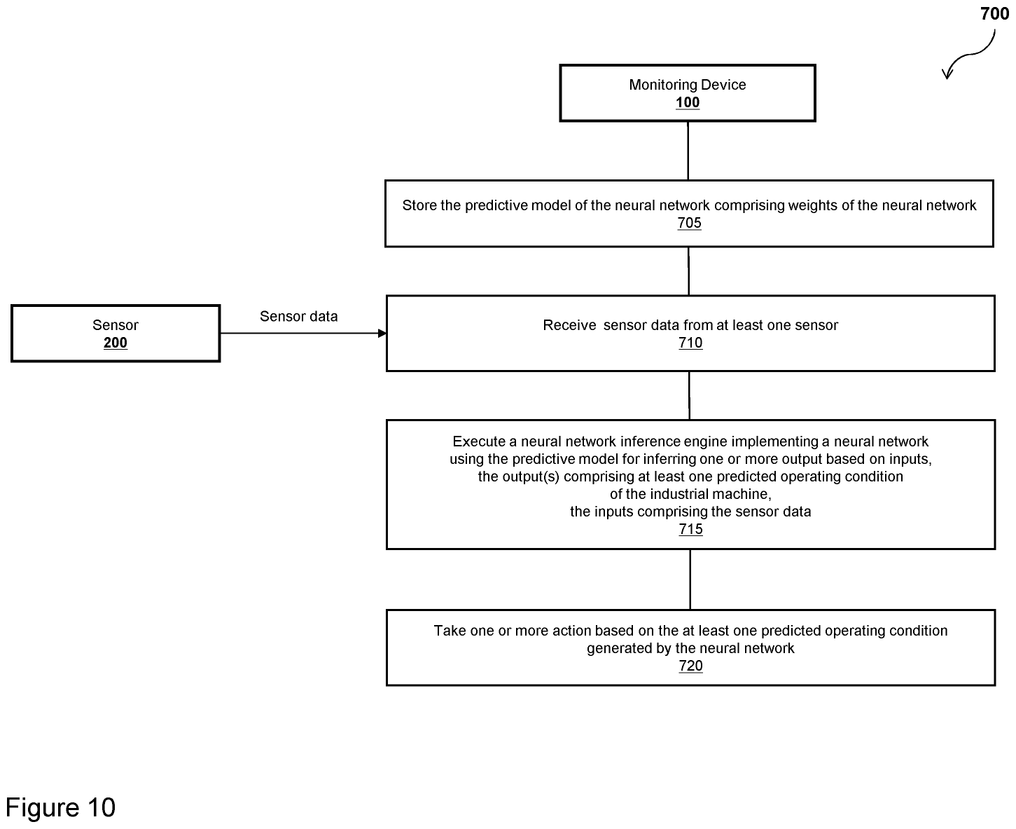

Reference is now made concurrently to FIGS. 3, 4, 7, 8 and 10, where FIG. 10 represents a method 700 for performing industrial machinery monitoring based on sensor data processing by a neural network. At least some of the steps of the method 700 are implemented by the processing unit 110 of the monitoring device 100.

Furthermore, a dedicated computer program has instructions for implementing at least some of the steps of the method 700. The instructions are comprised in a non-transitory computer-readable medium (e.g. in the memory 120) of the monitoring device 100. The instructions, when executed by the processing unit 110, provide for performing industrial machinery monitoring based on sensor data processing by a neural network. The instructions are deliverable to the monitoring device 100 via an electronically-readable media such as a storage media (e.g. any internally or externally attached storage device connected via USB, Firewire, SATA, etc.), or via communication links (e.g. via a communication network through the communication interface 130).

The method 700 comprises the step 705 of storing the predictive model of the neural network 113 in the memory 120 of the monitoring device 100. Step 705 is executed by the processing unit 110 of the monitoring device 100. The predictive model comprises the weights of the neural network 113.

As mentioned previously, in a first implementation illustrated in FIG. 3, the predictive model is directly generated by the neural network training engine 114 executed by the processing unit 110 and stored in the memory 120. In another implementation illustrated in FIG. 4, the predictive model is generated by the neural network training engine 114 executed by the processing unit 510 of the training server 500, and transmitted to the monitoring device 100 for storage in the memory 120.

The method 700 comprises the step 710 of receiving sensor data from at least one sensor 200. Step 710 is executed by the processing unit 110 of the monitoring device 100. A single sensor 200 is represented in FIG. 10 for simplification purposes. Alternatively, the sensor data are received from a plurality of sensors 200. The sensor data are received via one of the communication interface(s) 130 of the monitoring device 100.

The method 700 comprises the step 715 of executing the neural network inference engine 112. The neural network inference engine 112 implements the neural network 113, which uses the predictive model for inferring one or more output based on input. The one or more output comprises at least one predicted operating condition of the industrial machine 300. The inputs comprise the sensor data received at step 710. Step 715 is executed by the processing unit 110 of the monitoring device 100.

As mentioned previously, the predicted operating condition(s) inferred by the neural network 113 include without limitations: prediction of a failure of the industrial machine 300, prediction of the occurrence of an event related to the industrial machine 300, prediction of a production load of the industrial machine 300, prediction of a quality of a product produced by the industrial machine 300, prediction of a restart cycle pattern of a component of the industrial machine 300, prediction of a load and/or usage (e.g. mechanical load) of a component of the industrial machine 300, prediction of a condition for activating an auxiliary sensor 200′ in charge of monitoring the industrial machine 300.

Although details related to the implementation of step 715 are provided with respect to predicted operating condition(s) consisting of failure prediction(s) related to the industrial machine 300, a person skilled in the art will readily adapt the implementation of step 715 to the aforementioned other types of predicted operating condition(s) generated by the neural network 113. Furthermore, a person skilled in the art will readily adapt the implementation of step 715 to other types of machine learning algorithms (using the same inputs for generating the same outputs as the neural network 113).

In an exemplary implementation mentioned previously, the sensor data used as inputs comprise at least one of the following: a temperature related to the industrial machine 300, a measurement representative of a vibration related to the industrial machine 300, and a sound intensity related to the industrial machine 300. However, any combination of the inputs which have been described previously in relation to FIGS. 7 and 8 are applicable top step 715.

Optionally, the inputs also comprise additional data not received from the sensors 200. For example, the additional data are directly generated by the processing unit 110 of the monitoring device 100. Alternatively, the additional data are received from a remote computing device (e.g. from the user device 420 represented in FIG. 3) via one of the communication interface(s) 130 of the monitoring device 100. Examples of additional data comprise entries from a maintenance scheduling software, observations from an operator or a machinist, etc.

As mentioned previously, a person skilled in the art would readily adapt the method 700 to use other types of machine learning algorithms in place of the neural network 113 disclosed at step 715.

The method 700 comprises the step 720 of taking one or more action based on the at least one predicted operating condition (e.g. failure prediction) generated at step 715. Step 720 is executed by the processing unit 110 of the monitoring device 100. Following are several exemplary implementations of step 720. The execution of step 720 may result in the execution of one or more of the following exemplary implementations.

One exemplary implementation of step 720 comprises displaying information on the display 150 of the monitoring device 100. The information (e.g. an alert indicating that a failure of the industrial machine 300 is likely to occur) is generated based on the at least one failure prediction generated at step 715.

Another exemplary implementation of step 720 comprises transmitting information to a remote computing device (e.g. to the user device 420 represented in FIG. 3) via one of the communication interface(s) 130 of the monitoring device 100. The information (e.g. an alert indicating that a failure of the industrial machine 300 is likely to occur) is generated based on the at least one predicted operating condition (e.g. failure prediction) generated at step 715.

Still another exemplary implementation of step 720 comprises generating one or more command for controlling operating conditions of the industrial machine 300 based on the at least one predicted operating condition (e.g. failure prediction) generated at step 715. The one or more command is transmitted via the communication interface 130 of the monitoring device 100 to a control device (not represented in the Figures). The control device is capable of executing the one or more command to control the operating conditions of the industrial machine 300. This procedure has been described previously in relation to step 640 of the method 600 illustrated in FIG. 9.

Yet another exemplary implementation of step 720 comprises transmitting feedback to the sensor(s) 200 via one of the communication interface(s) 130 of the monitoring device 100. More details on the type of feedbacks which can be transmitted will be provided in the following.

### Feedbacks Provided to the Machine Learning Algorithm Implemented by the Sensor

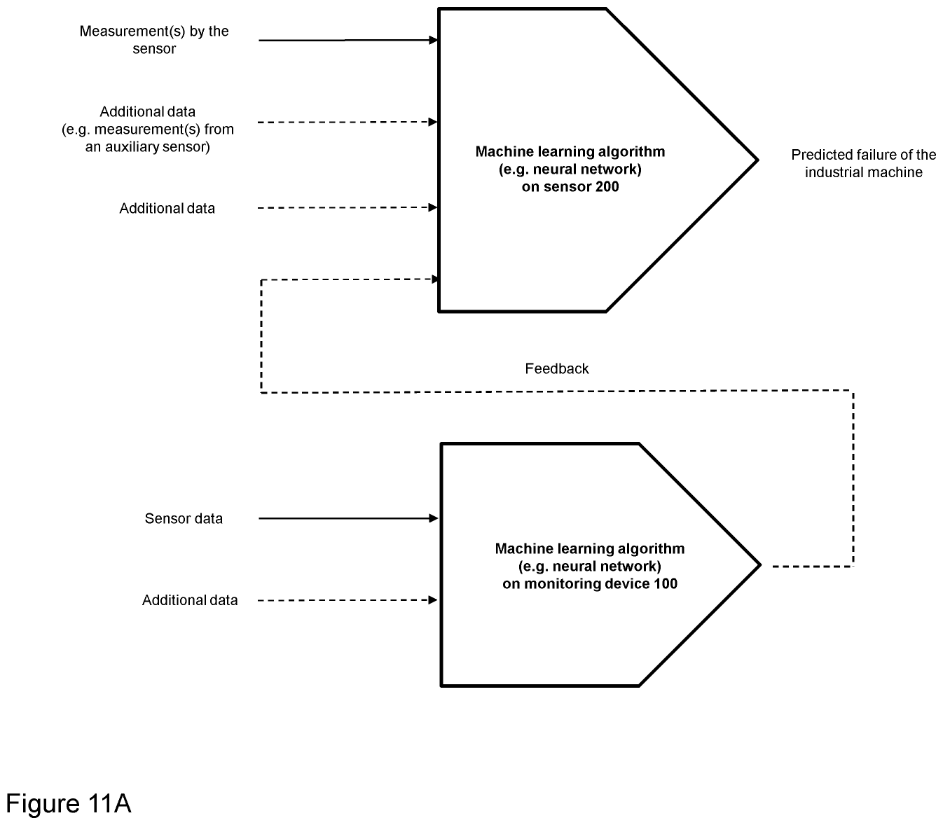

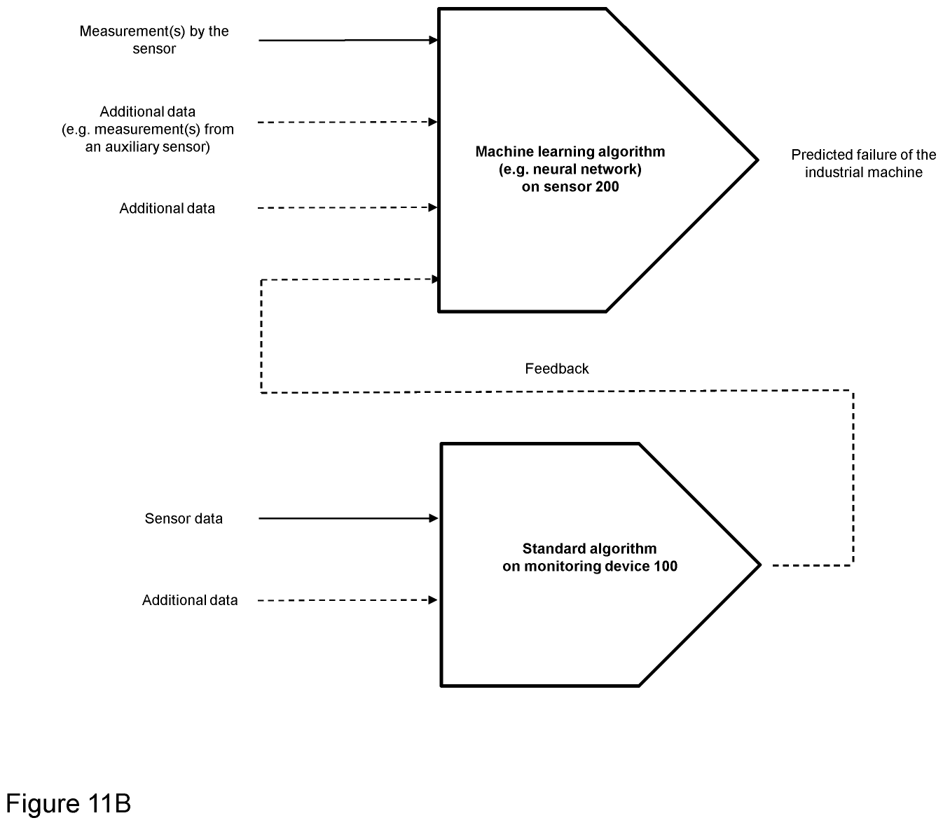

Reference is now made concurrently to FIGS. 2, 3, 6, 8, 11A and 11B. FIGS. 11A and 11B schematically represent the sensor 200 executing a machine learning algorithm (e.g. the neural network 113 illustrated in FIG. 8). The inputs of the machine learning algorithm executed by the sensor 200 have been described previously (e.g. measurements performed by the sensor 200, optionally additional data generated and transmitted by the auxiliary sensor(s) 200′, etc.).

The introduction of a feedback mechanism will be described in the case where the output(s) of the neural network 1130 comprise a predicted failure of the industrial machine 300. A person skilled in the art will readily adapt the feedback mechanism to the other types of (previously described) predicted operating condition(s) of the industrial machine 300 generated by the neural network 113.

Additionally, the inputs of the machine learning algorithm executed by the sensor 200 comprise a feedback generated and transmitted by the monitoring device 100. FIG. 11A illustrates a first exemplary use case where the feedback is generated by a machine learning algorithm executed by the monitoring device 100. FIG. 11B illustrates a second exemplary use case where the feedback is generated by a standard algorithm executed by the monitoring device 100. The terminology standard algorithm refers to an algorithm which does not use machine learning functionalities.

Although a single feedback is represented in FIGS. 11A and 11B, several feedback values may be generated by the monitoring device 100 and transmitted to the sensor 200, to be used as inputs of the machine learning algorithm executed by the sensor 200. In this case, all the feedback values are generated by the same algorithm executed by the monitoring device 100. Alternatively, the feedbacks values are generated via more than one algorithm executed by the monitoring device 100.

As mentioned previously, the inputs of the algorithm executed by the monitoring device 100 comprise sensor data transmitted by the sensor 200, optionally sensor data transmitted by one or more additional sensor (different from the sensor 200), and optionally additional data (which have been described previously). The sensor data transmitted by the sensor 200 comprise measurements generated by the sensor 200, and optionally output(s) of the machine learning algorithm executed by the sensor 200 (e.g. the predicted failure of the industrial machine 300).

For example, the inputs of the algorithm (illustrated in any of FIG. 11A or 11B) executed by the monitoring device 100 comprise the predicted failure of the industrial machine 300 generated by the machine learning algorithm executed by the sensor 200. The inputs further comprise one or more measurement generated by the sensor 200 and/or generated by at least one other sensor. One of the output(s) of the algorithm executed by the monitoring device 100 is a metric, which is representative of the possibility of occurrence of a failure of the industrial machine 300. The feedback, transmitted to the sensor 200 and used as input of the machine learning algorithm executed by the sensor 200, is based on this metric. In this exemplary use case, the feedback generated by the monitoring device 100 is used to improve the prediction made by the sensor 200 of the failure of the industrial machine 300. For this purpose, the monitoring device 100 uses data which are not available to the sensor 200 to generate the feedback (e.g. data originating from another sensor not in communication with the sensor 200). Alternatively or complementarily, the monitoring device 100 uses data available to the sensor 200, but which cannot be processed with an adequate algorithm by the sensor 200 (the monitoring device 100 implements the adequate algorithm).

In another example, the trained predictive model of the machine learning algorithm executed by the sensor 200 comprises several parameters, which are fine-tuned based on the feedback data. This allows to improve the predictive model without having to retrain it. For instance, a compressor of the industrial machine 300 generates different vibration patterns depending on the production load, the external temperature, and the scheduled maintenance job. Fine-tuning of the predictive model is performed based on feedback data from at least one of the following, an operator, a mechanician, or the sensor 200 itself.

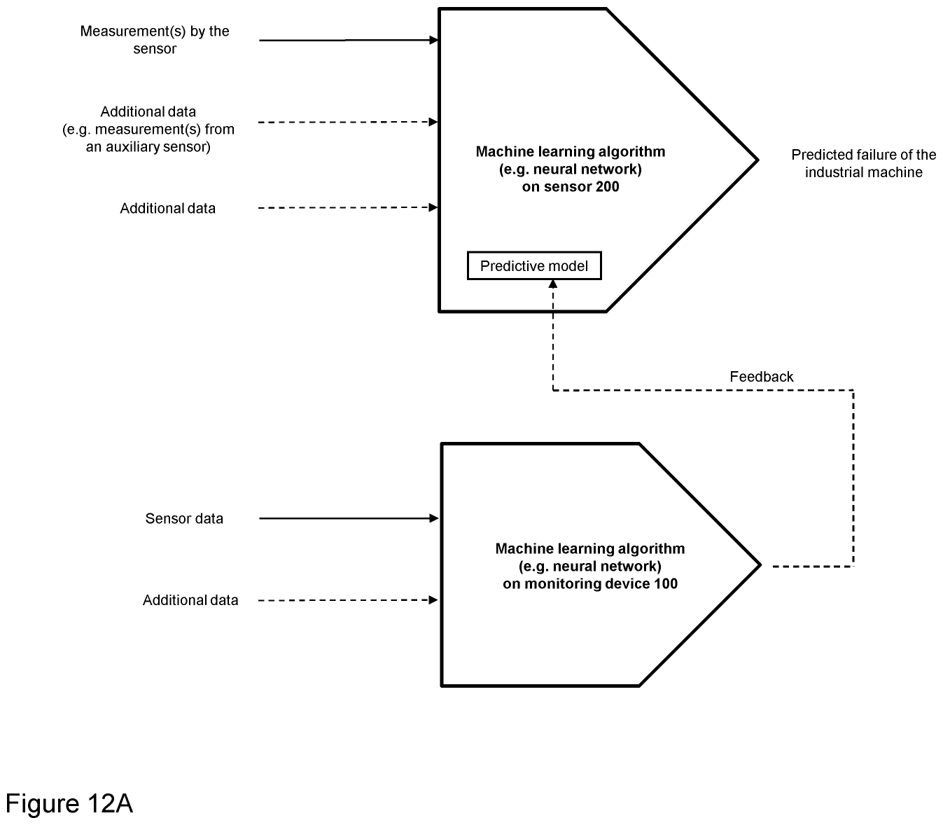

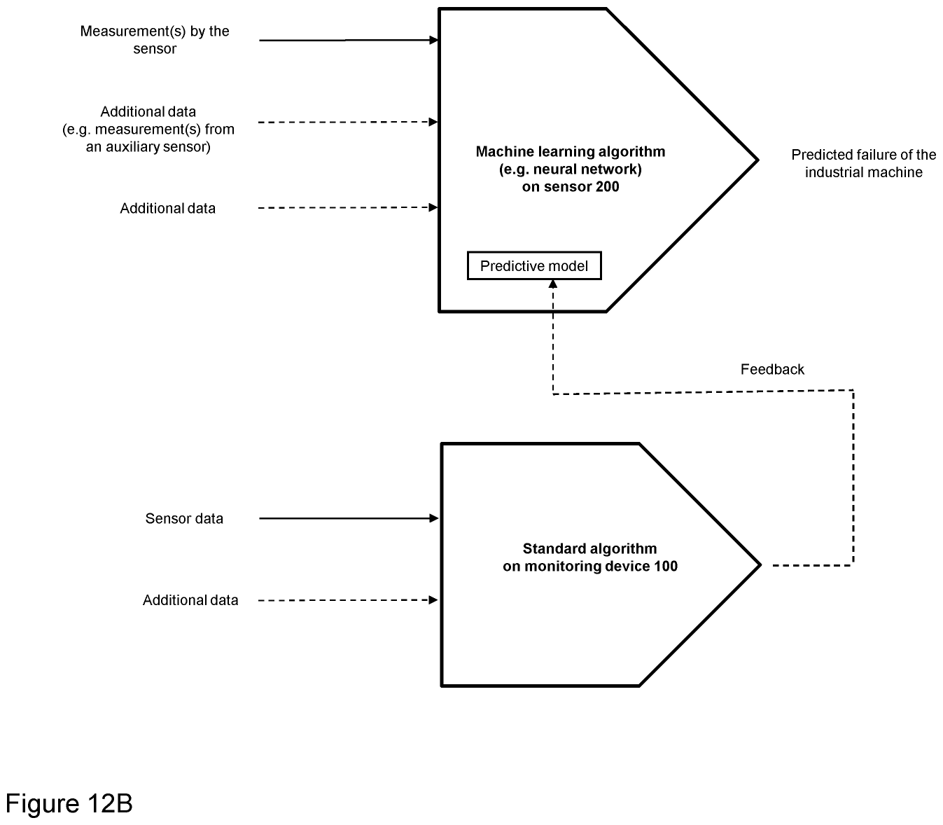

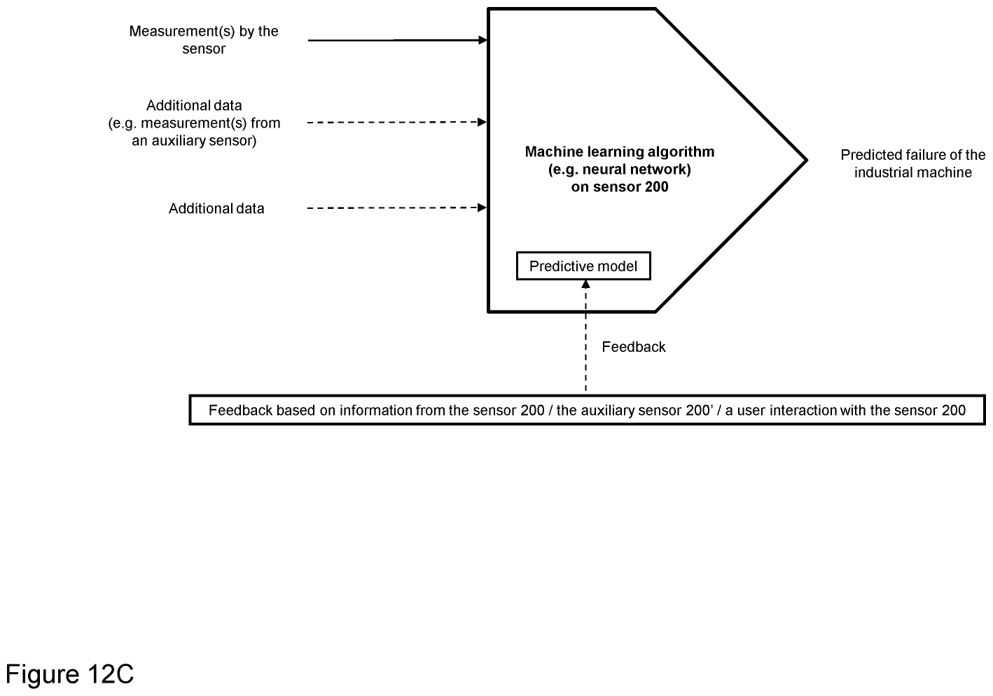

Reference is now made concurrently to FIGS. 2, 3, 6, 8, 12A and 12B. FIGS. 12A and 12B are respectively similar to FIGS. 11A and 11B, except for the feedback being used for updating the predictive model of the machine learning algorithm executed by the sensor 200. For example, updating the predictive model comprises updating pre-defined parameters of the predictive model, in order to fine-tune the behavior of the machine learning algorithm executed by the sensor 200 (e.g. adjusting the weights of the neural network 113 illustrated in FIG. 8).

If the feedback is used during the training phase of the machine learning algorithm executed by the sensor 200, the feedback provided by the monitoring device 100 is used for generating or improving the predictive model. Once the training is completed, the predictive model is used in an operational phase, to perform effective predictions of a failure of the industrial machine 300.

If the feedback is used during the operational phase of the machine learning algorithm executed by the sensor 200, the feedback provided by the monitoring device 100 is used for improving the predictive model, while the sensor 200 is currently performing effective predictions of a failure of the industrial machine 300.

One exemplary technique used in the context of neural networks is reinforcement learning. The feedback provided by the monitoring device 100 is a metric representative of the accuracy of the failure prediction (of the industrial machine 300) generated by the neural network 113 executed by the sensor 200. For example, the monitoring device 100 implements a dedicated algorithm capable of generating the metric representative of the accuracy of the failure prediction based on data collected by the monitoring device 100. FIG. 12A illustrates an implementation of the dedicated algorithm consisting of a machine learning algorithm and FIG. 12B illustrates an implementation of the dedicated algorithm consisting of a standard algorithm. For a current set of inputs and the corresponding output(s) of the neural network 113, if the feedback received from the monitoring device 100 is indicative of the failure prediction (of the industrial machine 300) generated by the neural network 113 being accurate, then a positive reinforcement signal (also referred to as a positive reward) is generated by the sensor 200 and used for performing the update of the predictive model of the neural network 113. If the feedback received from the monitoring device 100 is indicative of the failure prediction (of the industrial machine 300) generated by the neural network 113 not being accurate, then a negative reinforcement signal (also referred to a negative reward) is generated by the sensor 200 and used for performing the update of the predictive model of the neural network 113. More specifically, the positive or negative reinforcement signals results in a corresponding update of the weights of the neural network 113. Details of the implementation of a reinforcement learning process are well known in the art of neural networks.

Reference is now made concurrently to FIGS. 6, 12A, 12B and 12C, where FIG. 12C illustrates the feedback used for generating and/or improving the predictive model of the machine learning algorithm executed by the sensor 200 being generated based on information originating from another source than the monitoring device 100.

In a first exemplary implementation, the feedback is generated based on information originating directly from the sensor 200. For example, the sensor 200 comprises one or more sensing component 240 capable of generating measurements, which are used for evaluating the accuracy of the failure prediction (of the industrial machine 300) generated by the machine learning algorithm executed by the sensor 200. The evaluation of the accuracy of the failure prediction results in the generation of the feedback.

In a second exemplary implementation, the feedback is generated based on information originating from one or more auxiliary sensor 200′ in communication with the sensor 200. For example, the one or more auxiliary sensor 200′ respectively comprises sensing component(s) 240 capable of generating measurements, which are used for evaluating the accuracy of the failure prediction (of the industrial machine 300) generated by the machine learning algorithm executed by the sensor 200. The evaluation of the accuracy of the failure prediction is performed by the sensor 200 and results in the generation of the feedback. The transmission of the measurements from the one or more auxiliary sensor 200′ to the sensor 200 has been previously described.

In a third exemplary implementation, the feedback is generated based on a combination of information (e.g. measurements) originating from the sensor 200 and one or more auxiliary sensor 200′ in communication with the sensor 200.

In a fourth exemplary implementation, the feedback is generated based on a user interaction with the sensor 200. For instance, the failure prediction (of the industrial machine 300) generated by the machine learning algorithm executed by the sensor 200 is transmitted to a computing device (e.g. a smartphone). The failure prediction is displayed on a display of the computing device, the feedback is provided by a user via a user interface of the computing device, and the feedback is transmitted to the sensor 200.

Although the present disclosure has been described hereinabove by way of non-restrictive, illustrative embodiments thereof, these embodiments may be modified at will within the scope of the appended claims without departing from the spirit and nature of the present disclosure.

What is claimed is:

1. A sensor adapted to perform industrial machinery monitoring based on sensor data processing by a machine learning algorithm, the sensor comprising:
at least one communication interface;
memory storing a predictive model of the machine learning algorithm;
at least one sensing component adapted to generate measurements, the measurements comprising at least one of the following: a temperature related to an industrial machine, a measurement representative of a vibration related to the industrial machine, and a sound intensity related to the industrial machine; and
a processing unit comprising one or more processor configured to:
receive from the at least one sensing component the measurements; and
execute the machine learning algorithm, the machine learning algorithm using the predictive model for inferring one or more output based on inputs, the one or more output comprising at least one predicted operating condition of the industrial machine, the inputs comprising at least some of the measurements.

2. The sensor of claim 1, wherein the at least one predicted operating condition of the industrial machine comprises at least one of the following: a general failure prediction of the industrial machine and a failure prediction of a component of the industrial machine.

3. The sensor of claim 1, wherein the at least one predicted operating condition of the industrial machine comprises at least one of the following: a prediction of a failure of the industrial machine, a prediction of an occurrence of an event related to the industrial machine, a prediction of a production load of the industrial machine, a prediction of a quality of a product produced by the industrial machine, a prediction of a restart cycle pattern of a component of the industrial machine, a prediction of a mechanical load of a component of the industrial machine, and a prediction of a condition for activating an auxiliary sensor in charge of monitoring the industrial machine.

4. The sensor of claim 1, wherein the machine learning algorithm implements a neural network, the predictive model comprising weights of the neural network.

5. The sensor of claim 1, wherein the inputs of the machine learning algorithm further comprise at least one of the following: an identification of a type of machinery to which the industrial machine belongs and an identification of a type of measurement point of the sensor.

6. The sensor of claim 1, wherein the processing unit further receives additional data from another device via the at least one communication interface, the additional data being used as inputs of the machine learning algorithm.

7. The sensor of claim 6, wherein the other device is another sensor adapted to generate measurements, the additional data used as inputs of the machine learning algorithm comprising at least one of the following measurements: a temperature related to the industrial machine generated by the other sensor, a measurement representative of a vibration related to the industrial machine generated by the other sensor, a sound intensity related to the industrial machine generated by the other sensor, an air pressure related to the industrial machine generated by the other sensor, a water pressure related to the industrial machine generated by the other sensor, an oil pressure related to the industrial machine generated by the other sensor, an air particles concentration generated by the other sensor and a carbon dioxide (CO2) level generated by the other sensor.

8. The sensor of claim 1, wherein the processing unit further transmits to a remote monitoring device via the at least one communication interface information based on the at least one predicted operating condition generated by the machine learning algorithm.

9. The sensor of claim 1, wherein the processing unit further transmits to a remote training server executing a machine learning training algorithm via the at least one communication interface training data based on at least some of the measurements, and receiving from the remote training server via the at least one communication interface the predictive model or an update of the predictive model.

10. The sensor of claim 1, wherein the processing unit updates the predictive model based on a feedback, the feedback being received from another device or the feedback being generated by the processing unit based on measurements performed by the sensor or measurements received from another sensor.

11. A method for performing industrial machinery monitoring based on sensor data processing by a machine learning algorithm, the method comprising:
storing in a memory of a sensor a predictive model of the machine learning algorithm;
receiving by a processing unit of the sensor measurements generated by at least one sensing component of the sensor, the measurements comprising at least one of the following: a temperature related to an industrial machine, a measurement representative of a vibration related to the industrial machine, and a sound intensity related to the industrial machine; and
executing by the processing unit of the sensor the machine learning algorithm, the machine learning algorithm using the predictive model for inferring one or more output based on inputs, the one or more output comprising at least one predicted operating condition of the industrial machine, the inputs comprising at least some of the measurements.

12. The method of claim 11, wherein the at least one predicted operating condition of the industrial machine comprises at least one of the following: a prediction of a failure of the industrial machine, a prediction of an occurrence of an event related to the industrial machine, a prediction of a production load of the industrial machine, a prediction of a quality of a product produced by the industrial machine, a prediction of a restart cycle pattern of a component of the industrial machine, a prediction of a mechanical load of a component of the industrial machine, and a prediction of a condition for activating an auxiliary sensor in charge of monitoring the industrial machine.

13. The method of claim 11, wherein the machine learning algorithm implements a neural network, the predictive model comprising weights of the neural network.

14. The method of claim 11, wherein the inputs of the machine learning algorithm further comprise at least one of the following: an identification of a type of machinery to which the industrial machine belongs and an identification of a type of measurement point of the sensor.

15. The method of claim 11, further comprising receiving additional data from another device, the additional data being used as inputs of the machine learning algorithm.

16. The method of claim 15, wherein the other device is another sensor adapted to generate measurements, the additional data used as inputs of the machine learning algorithm comprising at least one of the following measurements: a temperature related to the industrial machine generated by the other sensor, a measurement representative of a vibration related to the industrial machine generated by the other sensor, a sound intensity related to the industrial machine generated by the other sensor, an air pressure related to the industrial machine generated by the other sensor, a water pressure related to the industrial machine generated by the other sensor, an oil pressure related to the industrial machine generated by the other sensor, an air particles concentration generated by the other sensor and a carbon dioxide (CO2) level generated by the other sensor.

17. The method of claim 11, further comprising transmitting to a remote monitoring device via the at least one communication interface information based on the at least one predicted operating condition generated by the machine learning algorithm.

18. The method of claim 11, further comprising transmitting to a remote training server executing a machine learning training algorithm via the at least one communication interface training data based on at least some of the measurements, and receiving from the remote training server via the at least one communication interface the predictive model or an update of the predictive model.

19. The method of claim 11, further comprising updating by the processing unit of the sensor the predictive model based on a feedback, the feedback being received from another device or the feedback being generated by the processing unit of the sensor based on measurements performed by the sensor or measurements received from another sensor.

20. A non-transitory computer-readable medium comprising instructions executable by a processing unit of a sensor, the execution of the instructions by the processing unit of the sensor providing for performing industrial machinery monitoring based on sensor data processing by a machine learning algorithm by:
storing in a memory of a sensor a predictive model of the machine learning algorithm;
receiving by a processing unit of the sensor measurements generated by at least one sensing component of the sensor, the measurements comprising at least one of the following: a temperature related to an industrial machine, a measurement representative of a vibration related to the industrial machine, and a sound intensity related to the industrial machine; and
executing by the processing unit of the sensor the machine learning algorithm, the machine learning algorithm using the predictive model for inferring one or more output based on inputs, the one or more output comprising at least one predicted operating condition of the industrial machine, the inputs comprising at least some of the measurements.
